(19) United States
(12) Patent Application Publication
(10) Pub. No.: US 2016/0212082 A1
(43) Pub. Date: Jul. 21, 2016

(54) SYSTEM AND METHOD FOR SECURING ELECTRONIC MESSAGES

(71) Applicant: Bhavnani Technologies Inc., Scottsdale, AZ (US)

(72) Inventor: Rajan P. Bhavnani, Scottsdale, AZ (US)

(21) Appl. No.: 14/599,486

(22) Filed: Jan. 17, 2015

(51) Int. Cl. H04L 12/58; H04L 29/06

(52) U.S. Cl. CPC H04L 51/16; H04L 63/0428; H04L 63/0414

(57) ABSTRACT

A secure communication system (100), a method to make same, and method to use that provides security and privacy of electronic communication. The secure computer system (100) uses a computer device (101) and a secure communication device (102) to secure electronic communication between individual computers, devices, networks, and the internet (170). By the present invention, the computer device (101) is in communication with the secure communication device (102), and the secure communication device is in communication with a modem (140) which is in communication with the internet (170).

The computer device (101) having a first processor (116), a first memory device (120), a first video device (118), a first I/O interface (122), a second I/O interface (124) and a first bus (142) are provided. The first processor (116), the first memory device (120), the first video device (118), the first I/O interface (122) and the second I/O interface (124) are coupled to the first bus (142).

The secure communication device (102) having a second processor (134), a second memory device (138) and a third I/O interface (128) and a second bus (158) are provided. The second processor (134), the second memory device (138) and the third I/O interface (128) are coupled to the second bus (158) and wherein the first bus (142) and the second bus (158) are coupled to each other so as to allow the computer device (101) to communicate with the secure communication device (102), wherein the computer device (101) and the secure communication device (102) read electronic communications and share electronic communications with each other.

In another embodiment, a first email is generated having a first header which includes a first destination address, first origin address, and a first space for content. A second email is generated having a second header including a second destination address, a second origin address and a second space for content. The first email is inserted in the second space for content. The second email having the first email inserted is encrypted.

### FIELD OF INVENTION

The present invention generally relates to communications, communication systems, communication elements and the like; and more particularly, to the design of and uses of secure communication systems, modules and the design, making and use of same.

### BACKGROUND

Conventional communications involves the electronic transfer of data from one user/device to another user/device via a broad array of technologies such as electronic, wireless, optical, and the like. These technologies form networks that consist of millions of private, public, academic business, and government communication systems that are of local to global scope. These conventional communications may take the form of email, instant messaging, voice over internet protocol (VOIP), video calling, or the like. Unfortunately, these conventional communications have been plagued by having privacy issues, wherein confidential and/or proprietary information is capable of being breached, wherein and the confidential and/or proprietary information can be intercepted by a third party. This interception can have serious ramifications from loss of personal privacy, jeopardizing business, and having profound personal and economic damages to private, public, academic, business, and government entities such as loss of real property, intellectual property and/or the like.

More specifically, as an example with regard to a conventional email, an email is typically generated using a conventional computer device having a software-based email package (e.g. Microsoft Outlook, Mozilla Thunderbird or the like), or a web-based email package (e.g. yahoo.com, gmail.com, aol.com or the like). It should be understood that the conventional computer device includes many other communication devices such as cellular phones, pagers, tablets, or the like. Generally, the email package sets out a page having a header and a content space. The header contains metadata which can include, but is not limited to, a “From:” field where an email address is affixed, a “To:” field where one or more email addresses are affixed, a “Cc:” field and/or a “Bcc:” field where email addresses of others can be or cannot be affixed, a “Subject:” field where a general description of the content of the email is affixed, and a “Sent:” field where the date that the email was sent is affixed. It should be understood that the header may also include additional metadata information (e.g. IP addresses, routing data or the like) that is typically hidden from the sender and receiver. The content space can include, but is not limited to, a space where the sender puts information that the sender is trying to convey to the receiver. Typically, the content space can include text, attached files, web-linked content, or any combination of thereof.

Assuming that a conventional computer device is used and that the conventional computer device is configured such that it is connected to the internet either by wire, such as an ethernet cable or wirelessly though a router, modem, or the like. In conventional transmission of email, the conventional email with the header, metadata and the content in the email may travel though several service providers on its way to the receiver's email service provider and the receiver(s) identified in the “To:” field, “Cc:” field and “Bcc:” field portions of the header.

Generally speaking, there are three encryption processes such as, but not limited to, connection based encryption, end to end encryption, and connection based encryption in combination with end to end encryption. Commonly, these encryption processes are used when attempting to secure email or electronic communications as they travel across the various service providers and networks that make up the internet. Using a conventional computer device connected to a router and/or a modem which is subsequently connected to the internet is herein referred to as a conventional computer system. In the connection based encryption process, the content of a typical email that is generated in the conventional computer system is usually not encrypted. Connection based encryption is sometimes used to secure the connection between the sender's conventional computer system and the sender's email service provider (e.g. using secure sockets layer (SSL) or transport layer security (TLS)). When used, the connection based encryption process protects the email content and email metadata while it is traveling across the internet from the sender's conventional computer system to the sender's email service provider. However, while this process is used in many email packages there are several disadvantages such as, it is extremely difficult for an average email sender or receiver to use the email package securely. For example, it is difficult to determine if the connection between the sender's conventional computer system and the sender's email service provider is using connection based encryption, if the strongest available method of encryption is being used and if the connection has been compromised by a third-party. This is especially true when using a software-based email package. An average email sender or receiver is not knowledgeable enough to know what steps they could take to configure and securely use connection based encryption to secure or improve the security of the connection between the sender's conventional computer system and the sender's email service provider.

In addition, this process of connection based encryption between the sender's conventional computer system and the sender's email service provider does not continue to protect the email content or email metadata once it is received by the sender's email service provider. Thus, the sender's email service provider can read and retain the email content and email metadata. Moreover, the sender's email service provider can retain the email metadata, the email content or any additional information derived by reading or analyzing the sender's email metadata or email content. The sender's email service provider can also retransmit the email metadata, the email content or any additional information derived by reading or analyzing the sender's email metadata or email content to any third party with or without the approval or knowledge of the email's sender or the email's receiver. Additionally, it should be understood that email content or email metadata can be accumulated over time for additional analysis. Another problem with relying on connection based encryption is that it does not ensure that the connection based encryption is used on subsequent connections beyond the sender's email service provider en route to the receiver's email service provider and on to the receiver's conventional computer system. Thus, at any further step in the process, the email content and email metadata may be transmitted without any protection making it readable to any network or service provider it may pass through while traveling across the internet, thereby resulting in loss of personal privacy, jeopardizing business, and having profound personal and economic damages to private, public, academic, business, and government entities such as loss of real property, intellectual property or the like.

Even if connection based encryption is used on all the connections required for the email delivery process, the receiver's email service provider can also read and retain the email content and email metadata. If the receiver's email service provider wants to, the receiver's email service provider can retain and retransmit the email metadata, the email content or any additional information derived by reading or analyzing the sender's email metadata or email content to any third party with or without the approval or knowledge of the email's sender or email's receiver.

The second process, end to end encryption, is sometimes used when attempting to secure email content from the sender to the receiver as the email travels across the multiple steps between the various service providers and networks that make up the internet. When using end to end encryption the email content is encrypted in such a way that it can only be decrypted and read by the intended receiver's conventional computer system. Thus, the email content is protected from one end of the transmission (the sender's conventional computer system) to the other end of the transmission (the receiver's conventional computer system). By way of example, when using end to end encryption the content space of an email that is generated in the sender's conventional computer system is encrypted by the sender's conventional computer system using industry standard public key encryption software (e.g. S/MIME, PGP, GnuPG) based on a public key provided by the intended receiver.

However, the typical end to end encryption process has two significant limitations. The first limitation of using an end to end encryption process with conventional email is that it does not protect email metadata. Thus, while the email content may be secured, the information contained in the email metadata (e.g. the identity of the sender, the identity of the receiver, the date and time the email was sent, the date and time the email was received, the physical location and type of computer device or software used to send the email, and the physical location used to receive the email, and/or the like) is transmitted without any protection whatsoever making the email metadata readable to any network or service provider it may pass through while traveling across the internet.

The availability of email metadata may seem innocuous or unimportant when the email content is protected. However, even over relatively short periods of time, analysis can be used to breach privacy and collect private, confidential and/or proprietary information. By way of example, if an adult woman were to start contacting an OB/GYN, then contact closely associated females (e.g. her sister and/or mother), an unrelated adult male, and finally contacted a family planning organization (e.g. planned parenthood) one could reasonably deduce that the adult woman in question was pregnant and that the unrelated adult male was the father. In another example, someone in regular contact with an oncologist's medical practice is almost certainly a patient seeking cancer treatment. In yet another example, if a struggling company's executives started corresponding with a law firm that specializes in bankruptcy law one could readily deduce that the company is preparing to file for bankruptcy. This private information can be obtained solely by analyzing email metadata and does not require the ability to read the email content protected by end to end encryption. The resulting availability of email metadata thereby results in loss of personal privacy, jeopardizing business, and having profound personal and economic damages to private, public, academic, business, and government entities such as loss of real property, intellectual property or the like.

The second significant limitation of end to end encryption is that it usually requires both the sender and receiver to have and use complex, sophisticated, compatible and highly secure computing infrastructures; commonly know in the industry as Public Key Infrastructure (PKI). This PKI is required to distribute public keys and protect the corresponding private keys for either the sender or the receiver. This infrastructure is usually too complex or too expensive for an average email sender or receiver to deploy and is usually limited to large security conscious organizations (e.g. defense contractors, large information technology companies, government agencies, and the like). In addition, any errors made in the deployment and/or maintenance of this PKI poses a high risk of compromising the protection of past, present, and future email content.

The third process, connection based encryption in combination with end to end encryption, uses a combination of the two processes discussed above. However, even when the end to end and the connection based encryption processes are used together, the combination of problems discussed above allows metadata to be compromised and thus can be read, stolen and used by someone that is not the intended receiver.

Thus, it can be seen that there are several serious problems in securing and keeping communications confidential when using conventional communication security methods and technologies. Further, even when these methods and technologies are combined, the security and privacy issues remain.

Moreover, these vulnerabilities are routinely exploited by governments, companies and malicious 3^{rd} parties who capture electronic communications including emails thereby resulting in loss of personal privacy, jeopardizing business, and having profound personal and economic damages to private, public, academic, business, and government entities such as loss of real property, intellectual property or the like. For example, most smart-phones will automatically and continuously transmit requests to connect to any wifi network with the same names as wifi networks they have previously connected to. When a network responds affirmatively, the smart-phone automatically connects and begins transmitting electronic communications using that network. Malicious 3^{rd} party networks are routinely configured to respond affirmatively to any request for any network name resulting in smart-phones automatically being connected to the malicious 3^{rd} party networks; most often without the smart-phone owner's knowledge. Even when using a genuine publicly available wifi network (e.g. those commonly provided in airports, restaurants, public places, and the like) the wifi network is typically made available without any encryption (e.g. WAP2 or the like). Thus, anyone within range of the wifi network could use readily available equipment to read and record any unsecured data being transmitted; including the email content and email metadata as discussed above thereby resulting in loss of personal privacy, jeopardizing business, and having profound personal and economic damages to private, public, academic, business, and government entities such as loss of real property, intellectual property or the like.

It can be readily seen that electronic communications are susceptible to compromises in privacy and security, and effectively causes most senders or receivers to involuntarily and/or unwittingly reveal private information to third parties (i.e. network and/or email service providers, malicious 3^{rd} parties, and the like). Further, the conventional methods for privacy and security are insufficient and ineffective. Further, the limitations of the conventional methods of privacy and security, give most electronic communication senders or receivers a false sense of security. Therefore, an article, design, system, and method for preventing loss of personal privacy, jeopardizing business, and having profound personal and economic damages to private, public, academic, business, and government entities such as loss of real property, intellectual property or the like that is cost effective, simplistic, and is capable of being manufactured and used in large volume is highly desirable.

### SUMMARY OF THE INVENTION

We describe an article and method of use for securing an electronic communication. In the method for securing an electronic communication, a computer device is provided which is capable of generating an electronic communication. The electronic communication includes a header having metadata wherein at least a portion of the metadata is encrypted. Providing a “To:” field and a “From:” field in the header allows electronic addresses to be used for senders and receivers to be identified, respectively. Encrypting the “From:” field allows obfuscation of sender so as to keep the identity of the sender unknown to anyone reading the electronic communication without either permission or a private encryption key. Moreover, generating a content space for placing electronic content such as, but not limited to, audio files, text files, optical files, and the like and the subsequent encryption thereof provides security and privacy for the content in those files. Encrypting of electronic information can be achieved by any suitable mode of operation that allows for pseudo-random ciphertext for each occurrence of electronic information that is encrypted such as, but not limited to, Cipher-Block Chaining (CBC), Propagating Cipher-Block Chaining (PCBC), Cipher Feedback (CFB), or the like.

In another embodiment of the invention, a computer device having a first processor having a first input and a first output, a first I/O interface having a second input and second output, a memory device having a third input and a third output, and a bus line. A secure communication device having a second processor having a fourth input and a fourth output, a second I/O interface having fifth input and a fifth output, a second memory having an sixth input and a sixth output, and a second bus line, wherein the first bus line and the second bus are electronically coupled. The computer device generates a first electronic communication having a first “From:” field, a first “To:” field and a first content space located in the first memory. The first electronic communication is moved from the first memory in the first computer device to the second memory of the secure communication device. The software in the secure communication device reads and stores the first electronic communication in the second memory. The software generates a shell electronic communication having a second “From:” field, a second “To:” field and a second content space located in the second memory. The second “To:” field is completed with information identifying the same receiver as the first “To:” field. The software in the secure communication device places the first electronic communication within the second content space in the shell electronic communication. The secure communication device then encrypts the second content space, including the first electronic communication, using a public key associated with the receiver identified in the second “To:” field.

The secure communication device then sends the shell electronic communication to the receiver identified in the second “To:” field.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWING

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 is a greatly simplified schematic illustration showing components of a secure communication system having a computer device and a secure communication device;

FIG. 2 is a greatly simplified exploded illustration of a process flow for sending a secured email;

FIG. 3 is a greatly simplified illustration of a flow chart illustrating a process for sending a secure email;

FIG. 4 is a greatly simplified exploded illustration of the process flow for receiving a secure email;

FIGS. 5A and 5B are greatly simplified illustrations of a flow chart illustrating a process for receiving a secure email;

FIG. 6 is a greatly simplified system diagram showing encrypted tunnels for sending email between a sender using a secure communication device and a receiver using secure communication devices;

FIG. 7 is greatly simplified exploded illustration of an alternate process for sending a secure email; and

FIG. 8 is a greatly simplified exploded illustration of an alternate process flow for receiving a secure email.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms front, back, top, bottom, over, under, and the like in the Description and/or in the Claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF THE DRAWINGS

The following descriptions are of exemplary embodiments of the invention and the inventors' conceptions of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely a system, a device, and method for securing anonymity in electronic communication suitably adapted for any electronic communication such as, but not limited to email, instant messages, VOIP, and video calls that may be used by individual users, small and large business, and the like, that may be readily generalized by skilled artisans to any application of the disclosed system and method in accordance with various embodiments of the present invention.

Before addressing details of the drawing described below, some terms are defined and/or clarified.

The term “email” is intended to mean a specific type of electronic communication having a “To:” field wherein information intended to identify the receiver or receivers are placed, a “From:” field wherein information intended to identify the sender or senders are placed, and a content space wherein any electronic message or media can be placed such as, but not limited to, images, textual information, or the like.

The term “shell email” is intended to mean a specific type of electronic communication having a “To:” field wherein information intended to identify the receiver or receivers are placed, a “From:” field wherein an information intended to identify the sender or senders are placed, and a content space wherein any electronic message or media can be placed such as, but not limited to, images, textual information, or the like.

The term “memory device” is intended to mean any device or medium that can be used to record electronic information such as, but not limited to, hard drives, computer chips, compact discs (CD's), magnetic tapes, or the like. Moreover, other memory devices can be used such as, but not limited to removable storage devices, thumb drives, smart media, flash cards, floppy discs, and Zip discs, or the like.

The term “original email” is intended to mean a first electronic communication generated before the beginning of or during the securing process. Typically, this can be visualized as a blank email form having certain fields or areas wherein certain data is inserted. For example, a typical original email has a “To:” field, “From:” field, a “Cc:” field, “Bcc:” field, and a “Subject:” field. The data inserted into the various fields has informational value and helps guide and direct the original email to its intended receiver. It should be understood that different electronic communications can and may use different nomenclatures for similar functionalities. However, this differing nomenclature is contemplated and incorporated into the scope of the invention.

The term “I/O” is intended to mean any input/output device or system such as, but not limited to, keyboard, mouse, touch screen, voice interface, wifi, ethernet, fiber optic, bluetooth, radio frequency (rf), high frequency device (hf), very high frequency (VHF) and Satellite Communications (SatCom) or the like.

The term ““To:” field” is intended to mean a field in an electronic communication wherein information identifying the receiver, receivers, receiving device, receiving devices, receiving network, and/or receiving networks is found. This further includes all types of electronic addresses identifying the receiver such as but not limited to, phone number, email address, username, IP address, and the like.

The term ““Cc:” field” is intended to mean an optional field in an electronic communication wherein information identifying an additional receiver, receivers, receiving device, receiving devices, receiving network, and/or receiving networks are found. This further includes all types of electronic addresses identifying the receiver such as but not limited to, phone number, email address, username, IP address, and the like.

The term ““From:” field” is intended to mean a space in an electronic communication wherein information identifying the sender, senders, sending device, sending devices, sending network, and/or sending networks is found. This further includes all types of electronic addresses identifying the sender such as but not limited to, a phone number, an email an address, a username, an ip address, and the like. It should be understood by one of ordinary skill in the art that multiple fields may include similar information that could be used to identify the sender, senders, sending device, or sending devices.

The term “email address” is intended to mean information that identifies a user account and associated email service provider to which email messages are delivered.

The term “encryption” is intended to mean a process or a method that is used to encode information in such a way that only authorized parties can decode the information and read the same information. Typically, the information (sometimes presented as plaintext) is encoded by use of an encoding algorithm turning the information into unreadable information (sometimes presented as ciphertext). The encoding algorithm specifies how the message is encoded. Typically, the encoding algorithms are based on asymmetric mathematical models or the like.

The term “Public Key” is intended to mean mathematical information (typically in digital format), which is used as an input to an asymmetric key algorithm to encrypt or decrypt an electronic message. Typically, a public key is created along with a corresponding private key. The public key along with other information can be used as inputs into the encoding algorithm such that information encrypted using the public key can only be decrypted by using the corresponding private key. A public key, as the name implies, is generally a key that is distributed publicly. This allows members of the public to securely send messages to the holder of the corresponding private key.

The term “Private Key” is intended to mean mathematical information (typically in digital format), which is used as an input to an asymmetric key algorithm to encrypt or decrypt an electronic message. Typically, a private key is created at the same time as a matching public key. The private key is used as an input into the decoding algorithm such that information encrypted using the matching public key can be decrypted. Thus, in order to decrypt the encrypted message that was encrypted by the public key, the matching private key is needed. A private key, as the name implies, is generally kept private and not distributed to others. This allows only the private key holder to decrypt messages encrypted with the matching public key that the private key holder has distributed.

The term “Symmetric Key” is intended to mean a mathematical information (typically in digital format), which is used as an input to an encoding or decoding algorithm to encrypt or decrypt an electronic message, wherein the same key is used to encrypt and decrypt the electronic message.

The term “Router” is intended to mean any device that forwards information or data packets between or within a computer network. When a data packet comes into the router, the router reads the address information in the packet to determine its ultimate destination. Then using the information in its routing table or its routing policy, the router directs the packet to the network or device required. Routers perform traffic directing functions on the internet. A data packet is typically forwarded from one router to another through the networks that constitute the internet until it reaches the receiver's network.

The term “Internet” is intended to mean a global system of interconnected computer networks that use the standard internet protocol suite (TCP/IP) to link several billion devices worldwide. R is a network of networks that consists of millions of private, public, academic, business, and government networks, of local to global scope, that are linked by a broad array of electronic, wireless, optical networking technologies, and the like. The Internet carries an extensive range of information resources and services, such as email, the inter-linked hypertext documents and applications of the World Wide Web (WWW), the infrastructure to support email, and peer-to-peer networks for file sharing and telephony.

The term “bus” is intended to mean is a communication system that transfers data between components inside or between electronic systems such as a computer, a computer like system, or between computers. The bus includes all related hardware components such as, but not limited to, wired, wireless, optical fiber, and the like, and all software, including communication protocols and the like.

The term “Processor” is intended to mean any processing unit such as a central processing unit (CPU) that is available and appropriate. Many different processors are made and have different configurations such as, but not limited to, single core, multiple core, and the like. Processors can have many different functions that have been integrated onto and into an individual processing chip. All of these additions and inclusions are intended to be incorporated into the present invention.

The term “Internet Service Provider” is intended to mean any organization such as, but not limited to: Cox Communications, Comcast, and the like, that provides a service that receives and transmits electronic communication, or allows data to be stored or transferred to others. Also, the internet service provider can hold data for their customers.

The term “Email Service Provider” is intended to mean any organization that provides a service that receives and transmits electronic communication, or allows data to be stored or transferred to others. Also, the service provider can hold data for their customer. By way of example, organizations such as, but not limited to: Google, Yahoo, Drop Box, and the like.

The term “Electronic Information” is intended to mean any form of electronic information, media, and/or data such as, but not limited to, suitable form and/or information with any suitable media such as, but not limited to, textual material, audio material, video material, optical material, live data streams or the like or combination thereof.

The term “electronic communication” is electronic information that is capable of being transmitted to a receiver via any suitable electronic means or technology. Typically, an electronic communication includes certain information such as, but not limited to, identification of the senders, the receiver, as well as other information such as, but not limited to date sent, date received, subject, and the like.

The term “metadata” is intended to mean a part of an electronic communication that is non-content information. Typical examples of metadata include identification of the senders, identification the receivers, as well as other information such as, but not limited to date sent, date received, subject, and the like. Other valuable information is also sent as metadata which may include information in a header that contains information identifying the IP address used to send the electronic communication, the time sent, and the like.

The term “encrypted tunnel” is intended to mean a software protocol that allows for the secure movement of data within or across a network or networks. The making and use of encrypted tunnels are well known in the industry. Tunneling involves allowing a private network communication to be sent across a public network, such as the internet, through a process called encapsulation. The encapsulation process allows for data packets to appear as though they are of a public nature to a public network when they are actually private data packets, allowing them to pass through unnoticed. By way of example, commonly used types of encrypted tunnels may include but are not limited to: a virtual private network (VPN) such as but not limited to Layer 2 Tunneling Protocol (L2TP), Point-to-Point Tunneling Protocol (PPTP), Internet Protocol Security (IPSec) or the like or a connection such as but not limited to Hypertext Transfer Protocol (HTTP), Post office Protocol (POP), Internet Message Access Protocol (IMAP), Simple Mail Transfer Protocol (SMTP) or the like, secured using Secure Sockets Layer (SSL), Transport Layer Security (TLS) or the like. It is contemplated that new and varying technologies for creating and using encrypted tunnels may be used in the future and will be incorporated into the present.

The term “block” is intended to mean a certain unit of data that is of fixed size.

The term “block cipher” is intended to mean an algorithm operating on fixed length blocks of plaintext with an unvarying transformation that is specified by a symmetric key.

The term “mode of operation” is intended to mean an algorithm that uses a block cipher to provide confidentially or authenticity. The mode of operation describes how to repeatedly apply a block cipher's single-block operation to securely transform an amount of data larger a then a block. Encrypting data can be achieved by any suitable mode of operation that allows for pseudo-random ciphertext for each occurrence of electronic information that is encrypted such as, but not limited to, Cipher-Block Chaining (CBC), Propagating Cipher-Block Chaining (PCBC), Cipher Feedback (CFB), or the like.

The term “header” is intended to mean a mental construct that is part of an electronic communication, wherein the header contains the metadata for the electronic communication, thus making it separate from the content space.

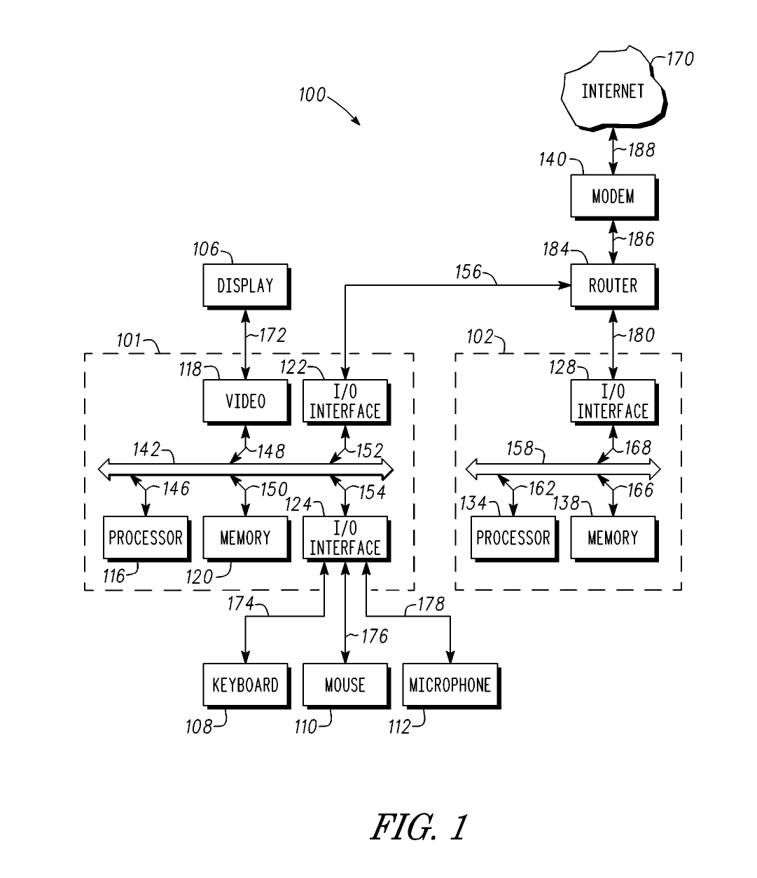

FIG. 1 is a simplified schematic illustration of a secure communication system 100 having a computer device 101 and a secure communication device 102 which are in communication with each other by any suitable means. As shown in FIG. 1, computer device 101 and a secure communication device 102 are shown as functional and device blocks, so as to illustrate, in general terms, functional interactions, devices, and interactions between computer device 101 and secure communication device 102. Computer device 101 and secure communication device 102 are enabled to execute computer software in conjunction with hardware that are programmed to provide a secure method to pass electronic information from a sender or senders to a receiver or receivers in a secure fashion so to prevent the invasion of privacy. Thus, computer device 101 and/or secure communication device 102 are programmed so that execution of instructions contained therein is achieved with any suitable operating system and/or language installed on computer device 101 and/or secure communication device 102.

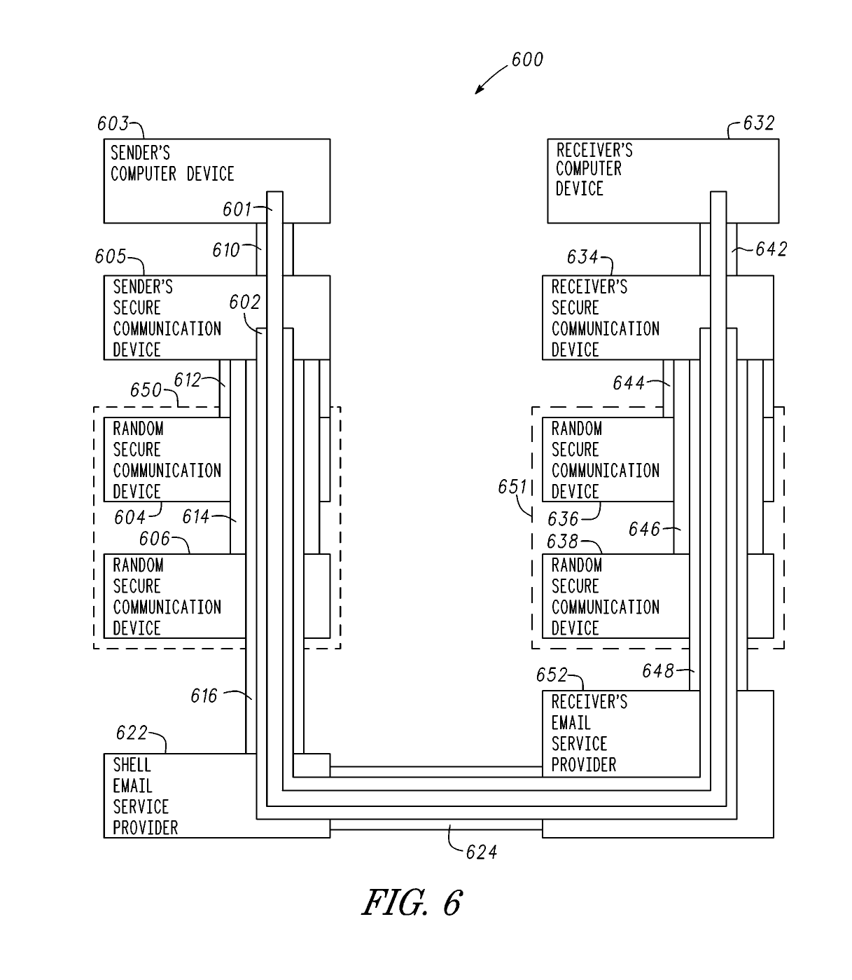

Briefly, referring to both FIG. 1 and FIG. 6, with FIG. 6 being a greatly simplified system diagram 600 showing encrypted tunnels 610, 612, 614, 616, 642, 644, 646, and 648 as required to send and/or receive an original email 601 between a sender's computer device 603 and a receiver's computer device 632.

It should be understood that sender's computer device 603 and receiver's computer device 632 can be considered similar to computer device 101 and as such both are capable of sending and receiving emails. However, for the sake of clarity these computer devices have been identified as sender's computer device 603 and receiver's computer device 632 based on the specific roles they play in system diagram 600. It should be further understood that a sender's secure communication device 605 and a receiver's secure communication device 634 can be considered similar to secure communication device 102 and as such both are capable of sending and receiving emails. However, for the sake of clarity the computer devices have been identified as the sender's secure communication device 605 and the receiver's secure communication device 634 based on the specific roles they play in system diagram 600. Additionally, it should be further understood that both sender's computer device 603 with sender's secure communication device 605 and/or receiver's computer device 632 with receiver's secure communication device 634 can be considered similar to secure communication system 100.

With regard to random secure communication devices 604, 606, 636 and 638, all have similar characteristics as described for sender's secure communication device 605 and receiver's secure communication device 634.

Generally, computer software and/or computer programs are sets of instructions that are able to be interpreted by computer device 101 and/or secure communication device 102, and when necessary and instructed, in combination with both secure communication device 102 and computer device 101 so as to perform desired tasks and functions. By way of example only, word processing programs, email programs, drafting programs, and the like are available for purchase and are capable of being run on computer device 101. These different programs include instructions which enable computer device 101 to perform the desired tasks of word processing, emailing, drafting and the like. Further, it should be understood that computer device 101 and secure communication device 102 can be consolidate into one device wherein some redundant devices can be removed.

Computer device 101 and secure communication device 102 may include, but are not required to include, several peripheral devices such as, but not limited to, a router 184, a video display 106, a keyboard 108, a mouse 110, a microphone 112, and the like. It should be understood that many more devices can be used in or with computer device 101 and secure communication device 102. Further, it should be understood that in some instances fewer devices can also be used depending upon the specific application and design of secure communication system 100.

It should be understood that secure communication device 102 and computer device 101 can be merged together so as to integrate the functions and process of secure communication device 102 into computer device 101.

Processors 116 and 134 are central processing units (CPU) that are capable of executing a variety of computer programs such as, but not limited to, operating system programs, computer application software, custom application software, and the like. Generally, any suitable CPU or the like can be used to execute the computer software. It is contemplated that technological improvements to both software and hardware would be incorporated in the present invention and would not reduce the scope of the present invention. Typically, selection of processors 116 and 134 are design choices and apply to the individual design of computer device 101 and secure communication device 102, respectively. Also, it should be understood that in some instances other processing devices such as, but not limited to, Application Specific Integrated Circuit devices (ASIC), Micro-Logic devices, and the like can be used in place of or in addition to processors 116 and 134. Generally, processors 116 and 134 have both inputs and outputs represented by buses 146 and 162, respectively.

Memory devices 120 and 138 can be made of any suitable memory device or technology such as, but not limited to, FLASH memory, Dynamic Random Access Memory (DRAM), Magnetic Random Access Memory (MRAM), hard drives, memory sticks, optical discs, read only Memory devices, and the like. It is expected that as technology changes the types of memory technologies will change as well and are hereby incorporated herein. Generally, memory devices 120 and 138 have both inputs and outputs represented by buses 150 and 166, respectively.

The router 184 is positioned between a modem 140 and I/O interfaces 122 and 128 such that communications from internet 170 can be both inputted and outputted though both I/O interfaces 122 and 128. Router 184 can be made of any suitable network routing technology or device. It should be understood that router technology changes over time and that router technology and upgrades are anticipated by the present invention.

I/O interfaces 122, 124, and 128 can be made of any suitable I/O interface technology, or functional unit such as, but not limited to, a Peripheral Interconnect Bus (PCI Bus), Universal Serial Bus (USB), Small Computer System Interface Bus (SCSI Bus), or the like. Generally, I/O interfaces 122, 124, and 128 have both inputs and outputs represented by buses 152, 154 and 168, respectively. Generally, I/O interfaces 122, and 128 provide communication and coupling between computer device 101 and router 184 or secure communication device 102 via bus 156 and bus 180, respectively. Generally, I/O interface 124 provides communication and coupling between keyboard 108, mouse 110, and voice 112; and router 184 and internet 170, respectively.

Buses 142, 146, 148, 150, 152, 154, 156, 158, 162, 166, 168, 172, 174, 176, 178, 180, 186, and 188 can be made of any suitable technology so as to provide communication and electronic coupling of the various devices in and connected to both computer device 101 and secure communication device 102. Generally, any suitable means can be used to electronically couple the various devices found in computer device 101 and secure communication device 102 such as, but not limited to, cabling, metal traces, typically on printed circuit boards, optical cabling, optical waveguides, wifi, bluetooth, SatCom, internet, intranet, wide area network (WAN), local area network (LAN), or the like. It should be understood that buses 142, 144, 146, 148, 150, 152, 154, 156, 158, 162, 166, 168, 172, 174, 176, 178, 180, 186, and 188 provide the necessary coupling and/or connectivity so that appropriate inputs and outputs can be made to all of the various electronic devices found in and connected to computer device 101 and secure communication device 102.

As shown in FIG. 1, buses 142 and 158 are the main buses in computer device 101 and secure communication device 102, respectively. With regard to computer device 101, bus 142 is coupled to memory device 120 via bus 150; bus 142 is coupled to a video device 118 via bus 148 and video device 118 is further coupled to video display 106 via bus 172, bus 142 is coupled to I/O Interface 122 via bus 152 and I/O interface 122 is further couple to router 184 via bus 156, bus 142 is coupled to processor 116 via bus 146, bus 142 is coupled to memory device 120 via bus 150, and bus 142 is coupled to I/O Interface 124 via bus 154, I/O interface 124 is further coupled to keyboard 108, mouse 110, and microphone 112 via buses 174, 176, and 178, respectively. It should be understood by one of ordinary skill in the art that optical inputs and outputs such as fiber-optics, cameras, photo-sensors, or the like can also be used.

With respect to secure communication device 102, bus 158 is coupled to memory device 138 via bus 166, bus 158 is coupled to processor 134 via bus 162, bus 158 is coupled to memory device 138 via bus 166, bus 158 is coupled to I/O interface 128 via bus 168 and I/O interface 128 is further coupled to router 184 via bus 180.

As shown in FIG. 1, router 184 is coupled to modem 140 via bus 186, and modem 140 is coupled to internet 170 via bus 188 thus coupling router 184 to internet 170.

It should be understood that communication or coupling between computer device 101 and secure communication device 102 could also be achieved via a bus (not shown) between I/O interfaces 122 and 128.

It should be understood that both buses 142 and 158 are shown having arrow heads on both ends of buses 142 and 158 indicating that a plurality devices and/or methods can be used to couple to buses 142 and 158 together. It should also be understood that buses 142 and 158 can be integrated into a single bus (not shown), thereby connecting computer device 101 and secure communication device 102.

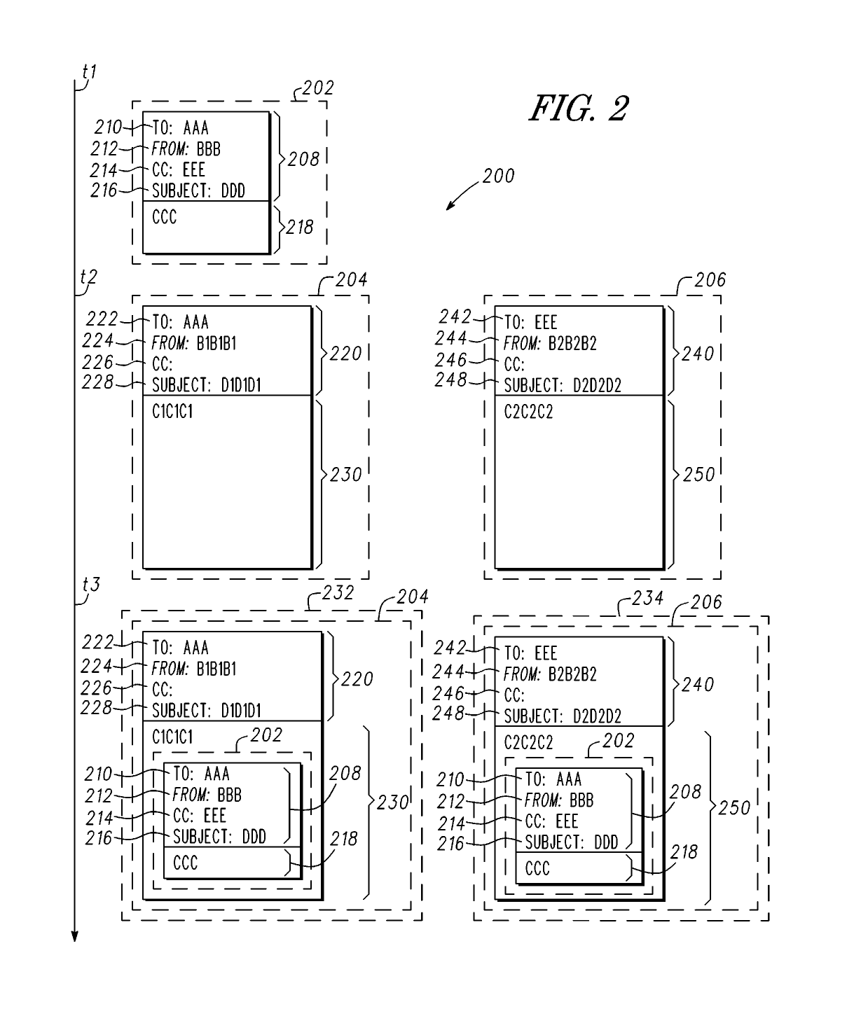

Referring now to FIG. 2 and FIG. 6, FIG. 2 is a greatly simplified exploded schematic illustration 200 of a portion of the process of sending a secure email. For the sake of clarity and to illustrate functional steps at different relative timing points, timing points t1, t2, and t3, have been identified in FIG. 2. It should be understood that t1, t2, and t3 are relative periods of time and do not reflect actual periods of time or the relative timing between points in time. It should be further understood that the sequencing of functional steps is achieved by both sender's computer device 603 and sender's secure communication device 605. Additionally, it should be understood, that while FIG. 2 illustrates a sequence of steps, use of different technologies, software, hardware, and communication processes between sender's computer device 603 and sender's secure communication device 605 can be used to alter the sequencing of the steps to improve the efficiencies in light of the technologies used. It should be further understood that the use of these changes or alterations do not change scope of the present invention.

As shown in FIG. 1 and in particular FIG. 2, the sender has generated an original email 202 on sender's computer device 603. The generation of a shell email 204 and a shell email 206 will be discussed herein below. Original email 202, shell email 204, and shell email 206 are made having certain parts or divisions, wherein original email 202 includes a header 208 having a “To:” field 210, a “From:” field 212 which may or may not be shown (“From:” field 212 is shown in FIG. 2 in italic for the sake of clarity), a “Cc:” field 214, a “Subject:” field 216, and a content space 218; wherein shell emails 204 and 206 are made having certain parts or divisions wherein shell emails 204 and 206 include headers 220 and 240 having “To:” fields 222 and 242, “From:” fields 224 and 244 which is typically not shown and is shown FIG. 2 in italicized font for clarity, “Cc:” fields 226 and 246, “Subject:” fields 228 and 248, and content spaces 230 and 250. Content spaces 230 and 250 can be filled with any suitable electronic information. As illustrated in FIG. 2, simple textual material, “CCC” (plaintext) is displayed in the content space 218; however more complicated and larger files as mention hereinabove may be attached to the email as part of the content space.

Typically and by way of example only, at t1, the sender launches an email program on computer device 101 which generates original email 202. The sender fills in the “To:” field 210 with the receiver's email address which is represented herein by “AAA”. As shown in FIG. 2, the “From:” field 212, is shown in italics, to indicated that, in some instances, “From:” field 212 is observable to the sender and in other instances the “From:” field 212 is not observable. The sender fills in the “From:” field 212 with the sender's email address which is represented herein by “BBB”. It should be understood that the observability is dependent upon the settings of the email program contained in sender's computer device 603. It should be further understood that “From:” field 212 is typically the sender's own email address and is generally stored in the email program whether the “From:” field 212 is observable or not. Also, it should be understood that the “From:” field 212 is typically filled in with the sender's own email address and is filled in automatically and stored by the sender's own email software because it is the sender's own software and sender's computer device 603 that initiates the original outgoing email 202. The sender then can fill in or cannot fill in the “Cc:” field 214.

With regard to “Cc:” field 214, typically, the sender fills in the “Cc:” field 214 with electronic information identifying additional receivers that the sender wants to send the original email to which is represented herein by “EEE”. Additionally, it should be understood that the “Cc:” field 214, the “Subject:” field 216, and the content space 218 do not necessarily have to exist or contain any data.

With regard to content space 218, the content space 218 is filled in by the sender with any desired electronic information and in any desirable format. The desired information can be loaded and/or filled in with any suitable form and/or information with any suitable media such as, but not limited to, textual material, audio material, video material, optical material, or the like or combination thereof. The electronic information of the sender's content space is represented herein by “CCC”.

Generally, during the process of filling in the information in header 208, at approximately the same time as the original email 202 is initiated or being composed by the sender of original email 202, or after the sender sends the original email from sender's computer device 603 to sender's secure communication device 605, the sender's secure communication device 605 can automatically or at the sender's discretion manually generate shell email 204 and/or shell email 206. Additionally, it should be understood that shell email 206 is generated when a second intended receivers of original email 202 is identified by the sender. In this specific example, a second intended receiver of original email is identified by the sender as “EEE” as shown in “Cc:” field 214. One skilled in the art will recognize that there are a multitude of ways to identify an additional intended receivers including but not limited to adding additional email addresses to the “To:” field 210, “Cc:” field 214, “Bcc:” field (not shown), or the like. In general, when multiple intended receivers are identified by the sender there will be multiple shell emails, exemplified by shell email 206, generated at t2.

It should be understood that “AAA” and “EEE” represent information identifying persons or devices as the intended receivers of original email 202. The electronic information and format of “AAA” and “EEE” may be presented or used in a multitude of ways that vary from across t1, t2 and t3. For example, the sender may enter a receiver's phone number in “To:” field 210, shown as “AAA”, while the receiver's email address is used in field “To:” field 222 at t2, also shown as “AAA”. Thus, allowing cross-linking of identification schemes to identify the same unique receiver.

It should also be understood, that t2 is only a relative timing point wherein several events can be controlled by software in the sender's secure communication device 605. For example, the automatic filling of appropriate data in certain fields such as, but not limited to, the “To:” fields 222 and 242 wherein the receiver identified in “To:” field 222 at t2, shown as “AAA”, is derived from or related to information entered by the sender in “To:” field 210 at t1, also shown as “AAA”, wherein the receiver in “To:” field 242 at t2, shown as “EEE”, is derived from or related to information entered by the sender in “Cc:” field 214 at t1, also show as “EEE”. Other examples of the automatic filling of certain fields at t2 may include but are not limited to, the “From:” fields 224 and 244, the “Cc:” fields 226 and 246, the “Subject:” fields 228 and 248, content spaces 230 and 250, and the like.

Shell emails 204 and 206 have headers 220 and 240, having “To:” fields 222 and 242, “From:” fields 224 and 244, “Cc:” fields 226 and 246, “Subject:” fields 228 and 248, and content spaces 230 and 250, respectively. As stated previously, with regard to “From:” field 212, the “From:” field 224 and 244 are sometimes not observable or are in the background. By way of example only, and as show in FIG. 2, the “From:” fields 224 and 244 at t2 are then filled in by either randomly assigning a novel and/or unique email address or manually by filling the “From:” fields 224 and 244 with a novel email address, represented herein by “B1B1B1” and “B2B2B2”, respectively.

As shown in FIG. 2 at t3, original email 202 is inserted into content spaces 230 and 250 of shell emails 204 and 206, respectively, by sender's secure communication device 605 or sender's computer device 603 depending upon actual setup of sender's secure communication device 605 and sender's computer device 603. Content spaces 230 and 250 of shell emails 204 and 206, respectively, at t3 are subsequently encrypted by any suitable program or method. For example, encryption of content spaces 230 and 250 at t3 could be accomplished by any suitable end-to-end encryption standard such as Secure/Multipurpose Internet Mail Extensions (S/MIME), or the like. Further, if using an encryption standard, based on public key cryptography, such as S/MIME, or the like, the public keys used to encrypt content spaces 230 and 250 at t3 should correspond to the receivers identified in headers 220 and 240 at t3, respectively. By placing original email 202 into content spaces 230 and 250 of shell emails 204 and 206 respectively, and using any suitable end-to-end encryption standard such as, but not limited to, Secure/Multipurpose Internet Mail Extensions (S/MIME), the original email 202 including header 208 can be encrypted, prior to sending to the intended receivers, despite the fact that end-to-end encryption normally does not allow for encryption of the header 208 of original email 202. This generates secure emails 232 and 234. The secure emails 232 and 243 are considered secure because both the content space 218 and header 208 of the original email 202 are protected. In addition, the headers 220 and 240 of shell emails 204 and 206 at t3 do not expose information contained in header 208 of original email 202 at t3. By way of example only, information contained in header 208 at t3 that is no longer exposed includes but is not limited to the “From:” field 212, “Cc:” field 214, “Subject:” field 216, and the like.

Further, the present invention allows for additional privacy and security of protected information such as metadata in header 208 of original email 202, including but not limited to the sender's identifying information, the subject, the number of intended receivers, or the identifying information of other intended receivers. This protected information is not capable of being secured by using other conventional methods and procedures commonly used when attempting to secure email or electronic communications. However, in the present invention this protected information has been secured.

Moreover, encrypting the header metadata prior to sending the electronic communication secures this protected information from being viewed by 3rd parties and service providers as the electronic communication travels to its intended receiver. Thus, the present invention further protects individuals from identification of their long-term, frequently contacted, and discreetly held associations, by preventing electronic communication metadata from being exposed and analyzed over time.

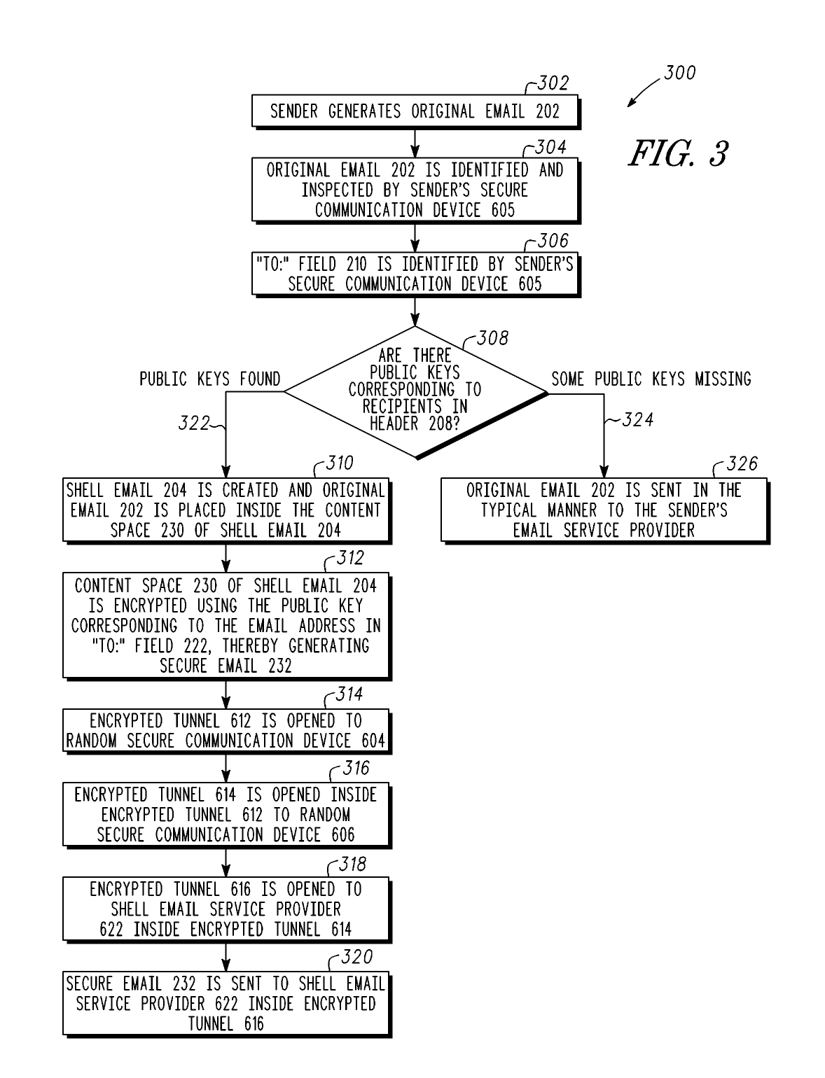

Referring now to FIGS. 1, 2, 3, and 6 with FIG. 3 being a greatly simplified illustration of a flow chart 300 of a process for sending secure email 232 wherein sender's computer device 603 and sender's secure communication device 605 work together. However, it should be understood that software and functions of sender's computer device 603 and sender's secure communication device 605 can be integrated into a single computer device such as sender's computer device 603. It should be further understood identifying numerals 302, 304, 306, 308, 310, 312, 314, 316, 318, 320 and 326 indicate steps and are referred to as steps herein while identifying numerals 322 and 324 indicate paths or directions from one step to another and are referred to as arrows herein. Additionally, it should be further understood that while the steps seem to be sequential other intervening steps can be used in an alternate order depending upon the specific circumstances and applications. Additionally, it should be understood, that while FIG. 3 illustrates a sequence of steps, use of different technologies, software, hardware, and communication processes between sender's computer device 603 and sender's secure communication device 605 can be used to alter the sequencing of the steps to improve the efficiencies in light of the technologies used. It should be further understood that the use of these changes or alterations do not change the breath and/or scope of the present invention.

Prior to use of sender's secure communication device 605, sender's secure communication device 605 has several start up software/hardware routines that are done such as, but not limited to, selecting random secure communication devices 604 and 606 from a plurality of secure communication devices 650 as further described in FIG. 6, checking hardware and software continuity and connectivity of sender's computer device 603 and sender's secure communication device 605, hardware and software continuity and connectivity between sender's secure communication device 605 and random secure communication device 604, hardware and software continuity and connectivity between sender's secure communication device 605 and random secure communication device 606 and hardware and software continuity and connectivity between sender's secure communication device 605 and shell email service provider 622. It should be understood that random secure communication devices 604, 606, 636 and 638 are connected to the internet as shown in FIG. 1. It should also be understood that there are many different techniques, methods, and types of hardware that can be used to provide connectivity and functionality between random secure communication devices 604, 606, 636 and 638.

Also, establishing secure communications between sender's computer device 603 and sender's secure communication device 605, between sender's secure communication device 605 and random secure communication devices 604 and 606 and between sender's secure communication device 605 and shell email service provider 622 will be discussed in greater detail in FIG. 3 and FIG. 6.

Referring now to FIGS. 1, 2, 3 and 6, as shown in FIG. 3, in step 302, the sender generates an original email 202. The original email 202 is generated as described in FIG. 2.

In step 304, encrypted tunnel 610, as shown in FIG. 6, is opened between sender's computer device 603 and sender's secure communication device 605. The original email 202 is sent from sender's computer device 603 to sender's secure communication device 605 using encrypted tunnel 610. It would be understood by one of ordinary skill in the art that if sender's computer device 603 and sender's secure communication device 605 are combined into a single sender's computer device 603 encrypted tunnel 610 may not be used.

As shown in step 306, the software in the sender's secure communication device 605 identifies the “To:” field 210 of original email 202 which has the email address of the receiver. Typically, the sender's secure communication device 605 records “To:” field 210 in any suitable memory device such as one similar, but not limited to, memory 120 and/or 138, and/or processor 116 and/or 134, or any combination thereof.

In step 308, the email addresses of the receivers identified in header 208 are used to search locally for public keys that are associated with the receivers' email addresses. Typically, a local search is achieved by searching memory devices 120 and/or 138. If the public keys are not found locally, sender's secure communication device 605 may also search remote databases that contain public keys. If public keys are found, either locally and/or remotely, that are associated with each receiver identified in header 208, secure communication device 102 proceeds down arrow 322 to step 310.

However, if some public keys cannot be found, either locally and/or remotely, for the receivers identified in header 208 then the original email is processed down arrow 324 to step 326, wherein the original email is processed in the typical manner (per MIME, POP, IMAP, etc) to the sender's email service provider (not shown), or may be sent to the intended receiver by some alternate process not described herein. Alternatively, if some public keys cannot be found, either locally and/or remotely, for the receivers identified in header 208 then the original email 202 can be processed down arrow 322 through step 310, 314, 316, 318, and/or 320 if desired to add some modicum amount of security.

Assuming that the public keys are found, as shown in step 310, sender's secure communication device 605 creates shell email 204 and original email 202 is inserted into content space 230 of shell email 204. It should be understood that information in header 208 including but not limited to “To:” field 210, “From:” field 212, “Cc:” field 214, “Subject:” field 216, and the like can be changed or encrypted to any desirable combination of letters, numerals, symbols and/or combination thereof. It should be further understood that by changing or not changing “To:” field 210, “From:” field 212, “Cc:” field 214, “Subject:” field 216 and the like has no effect on delivery of shell email 204 since delivery of shell email 204 is controlled by header 220 of shell email 204.

In step 312, content space 230 of shell email 204 is encrypted by any suitable method or technique as discussed previously, thereby generating secure email 232. The only accessible information that is readable without decrypting content space 230 is the metadata available in header 220 of shell email 204. This retains the security and privacy of the digital information of the original email 202.

In step 314, encrypted tunnel 612, as shown in FIG. 6, is opened between sender's secure communication device 605 and any one of a plurality of secure communication devices 650 exemplified by individual random secure communication devices 604 and 606. This is exemplified by sender's secure communication device 605 being connected to random secure communication device 604 though encrypted tunnel 612. It should be understood that encrypted tunnels are well known in the art and need not be discussed in detail here.

In step, 316, encrypted tunnel 614 is opened inside encrypted tunnel 612, as shown in FIG. 6 between sender's secure communication device 605 and any one of a plurality of secure communication devices 650 exemplified by individual random secure communication devices 604 and 606. This is exemplified by sender's secure communication device 605 being connected to random secure communication device 606 by encrypted tunnel 614. By opening encrypted tunnel 614 inside encrypted tunnel 612 additional security and protection are provided to secure email 232, as shown in FIG. 6. The additional security and protection includes, but is not limited to, masking the IP address of sender's secure communication device 605 from random secure communication device 606, and preventing random secure communication device 604 from identifying and/or reading electronic information sent using encrypted tunnel 614 including but not limited to secure email 232.

In step 318, sender's secure communication device 605 opens encrypted tunnel 616 to shell email service provider 622 inside encrypted tunnel 614. By opening encrypted tunnel 616 inside encrypted tunnel 614 inside encrypted tunnel 612 additional security and protection are provided to secure email 232 as shown in FIG. 2. The security and protection includes, but is not limited to, masking the IP address of the shell email service provider 622 from random secure communication device 604, masking the IP address of sender's secure communication device 605 from shell email service provider 622, and preventing random secure communication device 606 from identifying the IP address of sender's secure communication device 605 and/or reading electronic information sent using encrypted tunnel 616 including but not limited to secure email 232. The shell email service provider 622 would only be able to identify the IP address of random secure communication device 606, but not the IP address of sender's secure communication devices 605 or random secure communication device 604. Similarly, random secure communication device 606 would only be able to identify the IP address of shell email service provider 622 and random secure communication device 604, but not the IP address of sender's secure communication device 605. Additionally, random secure communication device 604 would only be able to identify the IP address of sender's secure communication devices 605 and random secure communication device 606, but not the IP address of shell email service provider 622. By using encrypted tunnel 616, inside encrypted tunnel 614, inside encrypted tunnel 612, only sender's secure communication device 605 will have knowledge of the entire path that secure email 232 will travel when being sent from sender's secure communication device 605 to shell email service provider 622.

In step 320, the secure email 232 is sent from sender's secure communication device 605 to shell email service provider 622 using encrypted tunnel 616.

It should be further understood that the sender's email service provider (not shown) is the email service provider associated with the sender's email address, shown in FIG. 2 as “BBB”. This may be the same as the shell email service provider 622 which is the email service provider associated with the email address show in the “From:” field 224 of the shell email 204, shown in FIG. 2 as “B1B1B1”. In addition, the sender's email service provider (not shown) may be the same as receiver's email service provider 652 which is the email service provider associated with the email addresses show in “To:” fields 222 and/or 242, shown in FIG. 2 as “AAA” and “EEE”, respectively.

It should be understood by one skilled in the art that the shell email service provider 622 and/or the sender's email service provider (not shown) have existing processes in place to facilitate the transfer of secure email 232 to the receiver's email service provider 652 when needed. This process will be described in more detail herein below in FIG. 6.

It should be additionally understood that shell email 206 and secure email 234 could be handled in the same manner shown in FIG. 3 as shell email 204 and secure email 232, respectively.

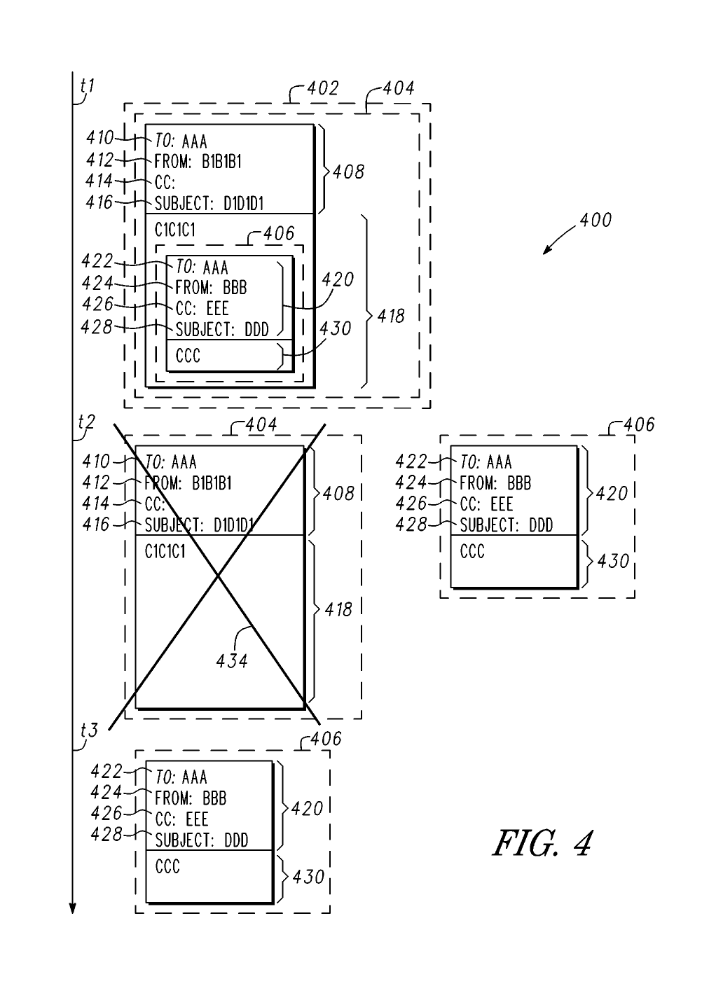

Referring now to FIG. 4 and FIG. 6, FIG. 4 is a greatly simplified exploded schematic illustration 400 of a process of receiving a secure email 402. Schematic illustration 400 illustrates receiving, decrypting, and processing secure email 402. Secure email 402 includes a shell email 404 and an original email 406, wherein shell email 404 includes a header 408 having metadata including but not limited to a “To:” field 410, a “From:” field 412, a “Cc:” field 414, a “Subject:” field 416, and a content space 418; and wherein original email 406 is located in content space 418 and is made of certain parts or divisions wherein original email 406 includes a header 420 having metadata which includes but is not limited to a “To:” field 422, a “From:” field 424, a “Cc:” field 426, a “Subject:” field 428 and a content space 430. Content spaces 430 and 418 can include any inputted suitable electronic media such as, but not limited to, textual material, audio material, optical material, or the like, wherein simple textual material “CCC” and “C1C1C1” is shown in FIG. 4 displayed in the content spaces 430 and 418, respectively, and wherein files or data streams as mention hereinabove may be added to content spaces 430 and 418 as attachments.

Typically and by way of example only, at t1, receiver's secure communication device 634 launches an email program which retrieves secure email 402 from receiver's email service provider 652, as shown in FIG. 6. Receiver's secure communication device 634 recognizes secure email 402. Once receiver's secure communication device 634 recognizes incoming secure email 402, receiver's secure communication device 634 decrypts content space 418 of secure email 402 to a readable status using any suitable means including a private key associated with receiver's email address or the like. The receiver's email address is identified in “To:” field 410 and is represented in FIG. 4 as “AAA”. The decryption enables the receiver's secure communication device 634 to identify and read original email 406, as well as content space 430 of original email 406. Also, it should be understood that by decrypting original email 406, “To:” field 422, “From:” field, 424, “Cc:” field 426, “Subject:” field 428 and content space 430 shown in FIG. 4 as “AAA”, “BBB”, “EEE”, “DDD”, and “CCC”, respectively, are now readable.

It should be understood that the metadata contained in header 420 of original email 406 can be the same as or different than the metadata contained in header 408 of shell email 404. Specifically as shown in FIG. 4, “To:” fields 410 and 422 both contain information identifying the same receiver, shown as “AAA”. However, “From:” field 412 and “Subject:” field 416 contain different information than “From:” field 424 and “Subject:” field 428 shown as “B1B1B1”, “D1D1D1”, “BBB” and “DDD”, respectively. One skilled in the art will recognize that if “BBB” identifies the sender of original email 406, “B1B1B1” identifies the sender of shell email 404, and “B1B1B1” cannot be directly or indirectly associated or correlated with “BBB” prior to the decryption of content space 418 then the identity of the sender of original email 406 was protected until content space 418 was decrypted by receiver's secure communication device 634. Similarly, if “DDD” identifies the subject of original email 406, “D1D1D1” identifies the subject of shell email 404, and “D1D1D1” cannot be directly or indirectly associated or correlated with “DDD” prior to the decryption of content space 418 then the subject of original email 406 was protected until content space 418 was decrypted by receiver's secure communication device 634. Additionally, any metadata that is present in header 420 of original email 406 and not present in header 408 of shell email 404 is also protected. For example, a second receiver, shown in FIG. 4 as “EEE”, is identified in “Cc:” field 426 of header 420, but “EEE” is not identified in “Cc:” field 414 of header 408.

With original email 406 being decrypted and capable of being read, any suitable action can be launched with regards to shell email 404 and original email 406. Actions can range from delivering original email 406 to receiver's computer device 632 while still contained within content space 418 of shell email 404, to storing or delivering shell email 404 to receiver's computer device 632 separately from original email 406, or deleting shell email 404 and only delivering original email 406 to receiver's computer device 632. These actions may be chosen and implemented manually by the receiver, or may be chosen and implemented automatically by receiver's secure communication device 634.

By way of example only and as shown in FIG. 4, at t1 secure email 402 includes shell email 404 and original email 406. So as to facilitate the use of original email 406 by the receiver and the receiver's computer device 632, shell email 404 is separated from original email 406. As shown in FIG. 4, at t2, receiver's secure communication device 634 separates the original email 406 from content space 418 of shell email 404, represented by original email 406 and shell email 404 being shown apart from each other at t2 of FIG. 4. As is further shown in FIG. 4 and by way of example only receiver's secure communication device 634 has also automatically deleted shell email 404. This action is illustrated by X 434 being drawn though shell email 404 at t2 of FIG. 4. With shell email 404 at t2 being deleted, only original email 406 along with its header 420 and content space 430 remain to be delivered to receiver's computer device 632 where it can be read by the receiver as shown at t3 of FIG. 4.

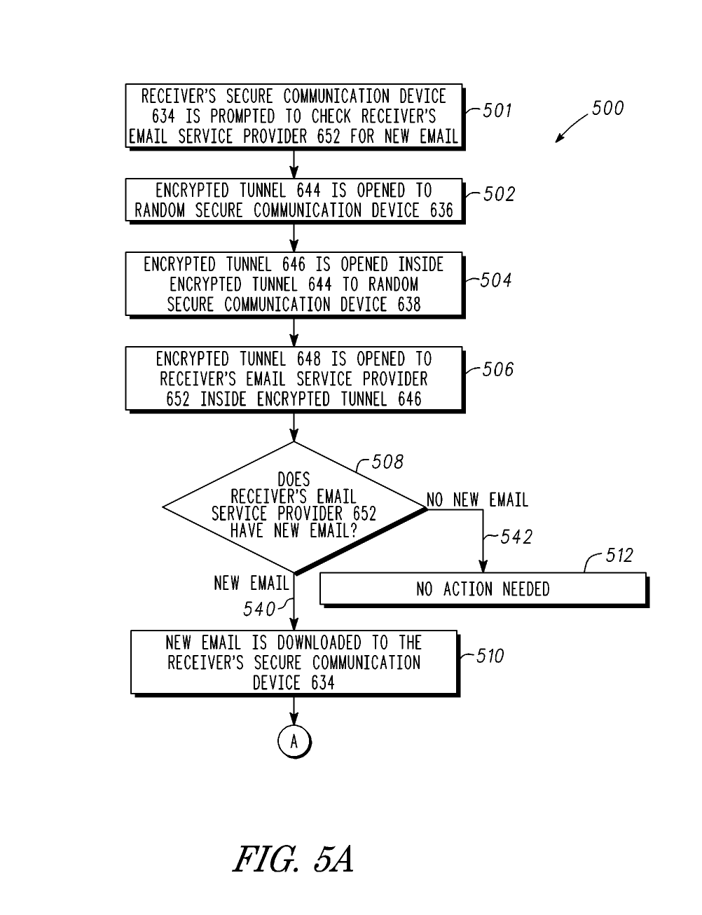

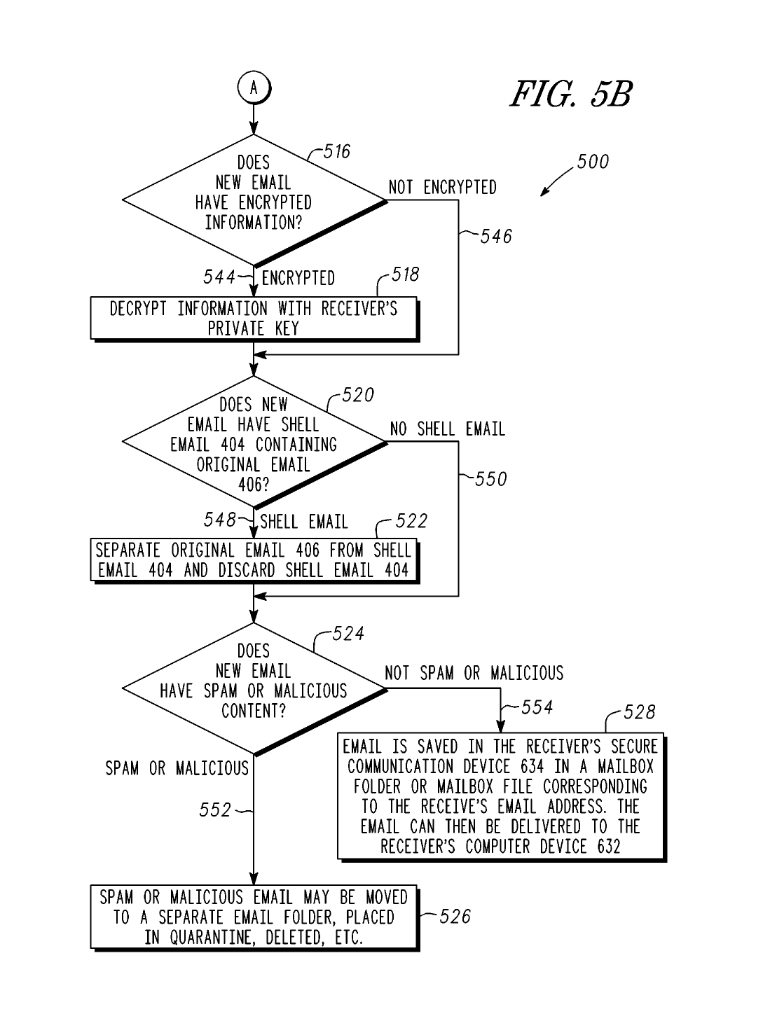

Referring now to FIGS. 4, 5A, 5B and 6 with FIG. 5A and FIG. 5B being a greatly simplified illustration of a flow chart 500 of a process for receiving a secure email wherein receiver's computer device 632 and receiver's secure communication device 634 work together. However, it should be understood that the software and functions of receiver's computer device 632 and receiver's secure communication device 634 can be integrated into a single receiver's computer device 632. It should be further understood identifying numerals 502, 504, 506, 508, 510, 512, 516, 518, 520, 522, 524, 526 and 528 indicate steps and are referred to as steps herein while identifying numerals 540, 542, 544, 546, 548, 550, 552, and 554 indicate paths or directions from one step to another and are referred to as arrows herein. Additionally, it should be further understood that while the steps seem to be sequential other intervening steps can be used in a modified order depending upon the specific circumstances and application.

Prior to use of receiver's secure communication device 634, receiver's secure communication device 634 has several start up software/hardware routines that are done such as, but not limited to, selecting random secure communication devices 636 and 638 from a plurality of secure communication devices 651 as will be further described in FIG. 6, checking hardware and software continuity and connectivity of receiver's computer device 632 and receiver's secure communication device 634, hardware and software continuity and connectivity between receiver's secure communication device 634 and random secure communication device 636, hardware and software continuity and connectivity between receiver's secure communication device 634 and random secure communication device 638 and hardware and software continuity and connectivity between receiver's secure communication device 634 and receiver's email service provider 652. It should be understood that random secure communication devices 604, 606, 636 and 638 are connected to the internet as shown in FIG. 1. It should also be understood that there are many different techniques, methods, and types of hardware that can be used to provide connectivity and functionality between random secure communication devices 604, 606, 636 and 638.

Establishing secure communications between receiver's computer device 632 and receiver's secure communication device 634, between receiver's secure communication device 634 and random secure communication devices 636 and 638 and between receiver's secure communication device 634 and receiver's email service provider 652 will be discussed in greater detail with reference to FIGS. 5A, 5B and 6.

Referring now to FIGS. 4, 5A, 5B and 6, in step 501, receiver's secure communication device 634 is prompted to check receiver's email service provider 652 for incoming email. Typically, this can either be accomplished automatically by an email program, by an automated request originating from the receiver's computer device 632 or the receiver can manually initiate the request to check the receiver's email service provider 652 from receiver's secure communication device 634 or receiver's computer device 632 so as to move incoming email from receiver's email service provider 652 to receiver's secure communication device 634 and/or receiver's computer device 632 where the receiver can view, read, and take any necessary action in response to the incoming email. Communication between receiver's secure communication device 634 and receiver's computer device 632 pass through encrypted tunnel 642 which can be opened by either receiver's secure communication device 634 or receiver's computer device 632. Once the commands to check for new incoming email are made either manually or automatically, the receiver's secure communication device 634 opens encryption tunnels 644, 646 and 648 so that the electronic communication can pass though encryption tunnels 644, 646 and 648 from receiver's email service provider 652 to the receiver's secure communication device 634 and/or receiver's computer device 632 in a safe, secure, and private manner. Moreover, it should be understood that the receiver's secure communication device 634, and at times in conjunction with the receiver's computer device 632, can inspect and interrogate multiple email accounts controlled by the receiver and process and/or integrate the emails received by the various accounts that are checked for incoming email.

As shown in step 502, encrypted tunnel 644 is established from receiver's secure communication device 634 to random secure communication device 636. As shown in step 504, receiver's secure communication device 634 establishes encryption tunnel 646 which is opened inside encryption tunnel 644 from receiver's secure communication device 634 to random secure communication device 638.

As shown in step 506, the receiver's secure communication device 634 establishes an encrypted tunnel 648 which is opened inside encryption tunnel 646 from receiver's secure communication device 634 to receiver's email service provider 652.

By opening encrypted tunnel 648 inside encrypted tunnel 646 and encrypted tunnel 646 inside encrypted tunnel 644 additional security and protection are provided as previously discussed in FIG. 3.

As shown in step 508, depending upon actual setup, either receiver's secure communication device 634 or receiver's computer device 632 interrogates receiver's email service provider 652 for new emails. As illustrated in FIG. 5 and step 508, the receiver's email service provider's response may be separated into new emails and no new emails. In the case, in which no new emails were found, a decision is illustrated by arrow 542 and terminating in step 512; no actions needed. Further, in the case, in which no action is required encrypted tunnels 648, 646, and 644 are closed. The closing of encrypted tunnels 648, 646, and 644 effectively isolates receiver's email service provider 652 from receiver's secure communication device 634 and receiver's computer device 632. In the case, in which new email are found, a decision, illustrated by arrow 540 leading to step 510.

As shown in step 510, if new emails are found at receiver's email service provider 652, they are subsequently downloaded to receiver's secure communication device 634 as shown in FIG. 6. It should be understood that the new emails which have been downloaded can be placed in receiver's secure communication device 634 in memory 138 as shown in FIG. 1, as well as receiver's computer device 632 in memory 120, or the like.

Generally, when operations are being done on the new emails, the new emails, in whole or in part, are moved to a processor such as processor 134 or 116 as shown in FIG. 1 where the operation such as storage, movement, interrogation, analysis and the like can be done.

As shown in step 516, after the new emails have been downloaded the new emails are interrogated for encrypted information by the receiver's secure communication device 634. It should be understood that the receiver's secure communication device 634 can work in conjunction with the receiver's computer device 632. As illustrated in step 516, the new emails will be categorized as new emails that contain encrypted information and new emails that do not contain encrypted information. In the case of new emails that do not contain encrypted information, a decision is made illustrated by arrow 546 wherein step 520 is reached. In the case of new emails that do contain encrypted information, a decision is made illustrated by arrow 544 wherein step 518 is reached. As illustrated in step 518 the encrypted information contained in the new emails is decrypted. Decryption is accomplished by any suitable means such as using the receiver's private key or the like. After the encrypted information has been decrypted, the new emails are also moved to step 520. All new emails at step 520 are interrogated for shell email 404 containing original email 406 as show in FIG. 4 at t1.

Further, it should be understood that if the new emails do not contain any encrypted information, the new emails may be processed directly to step 524 and continue as shown in FIGS. 5A and 5B.

As shown in step 520, the new emails are interrogated by the receiver's secure communication device 634 for presence of shell email 404 that contains original email 406. This is illustrated by shell email 404 containing original email 406 as shown in FIG. 4 at t1. It should be understood that the receiver's secure communication device 634 can work in conjunction with receiver's computer device 632. As illustrated in step 520, the new emails will be separated into new emails that have shell email 404 containing original email 406 and new emails that do not have shell email 404 containing original email 406. The format of shell email 404 containing original email 406 is illustrated by shell email 404 and original email 406 as shown in FIG. 4 at t1. In the case of new emails that do not have shell email 404 containing original email 406, a decision is made illustrated by arrow 550 wherein step 524 is reached. In the case of new emails that do have shell email 404 containing original email 406, a decision is made illustrated by arrow 548 wherein step 522 is reached. As shown in step 522, new emails that do have shell email 404 containing original email 406 are interrogated and original email 406 is removed from shell email 404 content space 418 as shown in FIG. 4 at t2 by way of original email 406 being shown separately from shell email 404. By way of example only, shell email 404 is deleted. This action is illustrated by X 434 being drawn though shell email 404 in FIG. 4 at t2. After shell email 404 is deleted the new emails are also moved to step 524 and the new emails may be further processed or interrogated as desired either manually by the receiver, automatically by the receiver's secure communication device 634, receiver's computer device 632 or the like.

As shown in step 524, the new emails illustrated by original email 406 in FIG. 4 at t3, may be further processed or interrogated as desired either manually by the receiver or automatically by receiver's secure communication device 634, receiver's computer device 632 or the like for the presence of spam, malicious content, the application of any other processes desired for managing or sorting new emails or the like. It should be understood that the receiver's secure communication device 634 can work in conjunction with receiver's computer device 632. As illustrated in step 524, by way of example only, the new emails will be separated into new emails that do not have any spam or malicious content, and new emails that do have spam or malicious content. In the case of new emails that do not contain spam or malicious content, a decision is made which is illustrated by arrow 554 wherein the new emails reach step 528 and are delivered to the receiver's computer device 632. In the case of new emails that do contain spam or malicious content, a decision is made which is illustrated by arrow 552 wherein the new emails reach step 526 wherein additional processes or decisions can be made based on the nature of the undesirable content detected, and are based on the security of the receiver and receiver's devices. This can be done automatically and/or manually.

FIG. 6 is a greatly simplified system diagram 600 showing encrypted tunnels 610, 612, 614, 616, 642, 644, 646, and 648 as shown to send and/or receive original email 601 between sender's computer device 603 and receiver's computer device 632.

Generally, the flow of email can start from the sending of an email from either sender's computer device 603 and/or receiver's computer device 632. It should be understood that sender's computer device 603 and/or receiver's computer device 632 are capable of both sending and receiving email.

More specifically and by way of example only, sender's computer device 603 is coupled to sender's secure communication device 605 via encryption tunnel 610.

Additionally and by way of example, receiver's computer device 632 is coupled to receiver's secure communication device via encryption tunnel 642.

Sender's computer device 603 and receiver's computer device 632 can be any suitable computing device such as, but not limited to a computer, e.g., a desktop, a laptop, a tablet, or the like, and further including any suitable portable device such as, but not limited to, a cell phone, a wireless communication device, an electronic book, or the like.

As shown in FIG. 6 the plurality of secure communication devices 650, exemplified by individual random secure communication devices 604 and 606, represent the plurality of secure communication devices that can be communicated with individually or as a whole by sender's secure communication device 605. Further, it should be understood that each individual random secure communication device within the plurality of secure communication devices 650 can have separate internet protocol address (IP address) on a network, such as but not limited to, a wide area network (WAN), a local area network (LAN), a intranet, a virtual private network (VPN), the internet, or the like. In addition, the plurality of secure communication devices 650 are not limited geographically with respect to their potential locations and may be selected by sender's secure communication device 605 for opening and use of encrypted tunnels that can be opened and used inside encrypted tunnels as shows in FIG. 6 exemplified by encrypted tunnels 612, 614, and 616 and discussed in detail in FIG. 3.

Additionally, the plurality of secure communication devices 651, exemplified by individual random secure communication devices 636 and 638, represent the plurality of secure communication devices that can be communicated with individually or as a whole by receiver's secure communication device 634. Further, it should be understood that each individual random secure communication device within the plurality of secure communication devices 651 can have separate internet protocol address (IP address) on a wide area network, can be located on the same local area network, can be located on an intranet, and/or can be located on the internet. In addition, the plurality of secure communication devices 651 are not limited geographically with respect to their potential locations and may be selected by receiver's secure communication device 634 for opening and use of encrypted tunnels that can be opened and used inside encrypted tunnels as shows in FIG. 6 exemplified by encrypted tunnels 644, 646, and 648 and discussed in detail in FIGS. 5A and 5B.

It should understood that the pluralities of secure communication devices 650 and 651 may be part of a larger plurality of secure communication devices (not shown) and as such may contain individual secure communication devices that are common between the pluralities of secure communication devices 650 and 651. It should further be understood that the pluralities of secure communication devices 650 and 651 may also contain individual secure communication devices that are not common between the pluralities of secure communication devices 650 and 651.

As shown in FIG. 6, shell email service provider 622 and receiver's email service provider 652 are connected to each other via a tunnel 624. Tunnel 624 may be established across a plurality of networks or communication technologies including but not limited to the internet. Tunnel 624 allows communication between shell email service provider 622 and receiver's email service providers 652 to communicate with each other. The presence of encryption or security associated with tunnel 624 is beyond the control of the sender or receiver of original email 601 and is managed and controlled by the shell email service provider 622 and the receiver's email service provider 652. As a result, when using traditional encryption processes such as, but not limited to, connection based encryption and/or end-to-end encryption, the sender of the original email 601 cannot control or guarantee the privacy and security of the email content and/or email metadata contained in the header as discussed previously. The ability to protect the privacy and security of both the content and metadata of original email 601 from the various email service providers and internet service providers used when traveling between the sender's secure communication device 605 and the receiver's secure communication device 634 is possible through use of the present invention. This is exemplified in FIG. 6 by the presence of shell email 602 which is present throughout the path taken by original email 601 from the sender's secure communication device 605 to the receiver's secure communication device 634.

Moreover, security and/or privacy breaches are very likely to occur while original email 601 is traveling through or stored within the various service provider's networks. As the service provider networks contain personal information of many individuals in one location they are the frequent target of malicious actors. In addition, many service providers' networks are designed to collect information about the individuals using their services by scanning their communications to develop targeted marketing profiles of the individuals; intruding on the private communications that travel on the service providers' networks. However, in the present invention the likelihood of such a security and privacy breach is greatly reduced or prevented because the content and metadata of original email 601 are protected while travel through or stored within the various service provider's networks. This makes analysis by service providers impossible. Additionally, widespread use of this invention will decentralize the location of the personal and private information of the individuals using it. Decentralization of the personal and private information of many individuals makes it harder for malicious actors to obtain the personal and private information of those individuals en mass because the personal and private information cannot be collected by gaining access to a single service provider's network or service.

Additionally, it should be understood that more than two individual secure communication devices from the pluralities of secure communication devices 650 and 651 can be used between sender's secure communication device 605 and shell email service provider 622 exemplified by random secure communication devices 604 and 606 and between receiver's secure communication device 634 and receiver's email service provider 652 exemplified by random secure communication devices 636 and 638, respectively. Typically, any suitable number of individual secure communication devices exemplified by random secure communication devices 604, 606, 636 and 638 can be used. While there is no upper limit to the number of individual secure communication devices, typically, the number of individual secure communication devices used range from two (2) to one-hundred (100) or more. Thus, as the number of individual secure communication devices used increases the difficulty of finding and tracking original email 601 and the sender's or receiver's IP addresses increases.

Moreover, it should be further understood that all email is sent and held at the receiver's email provider 652 and that the receiver, the receiver's secure communication device 634, receiver's computer device 632 or the like has to initiate, i.e., request delivery of the receiver's email to the receiver. However, with all electronic information having to pass though either sender's secure communication device 605 and/or receivers secure communication device 634, electronic information can be examined and sorted for potential threats and dealt with appropriately. Further, malicious, bad, and/or harmful electronic information can be stopped and isolated from reaching the receiver's computer device 632 by receiver's secure communication device 634.

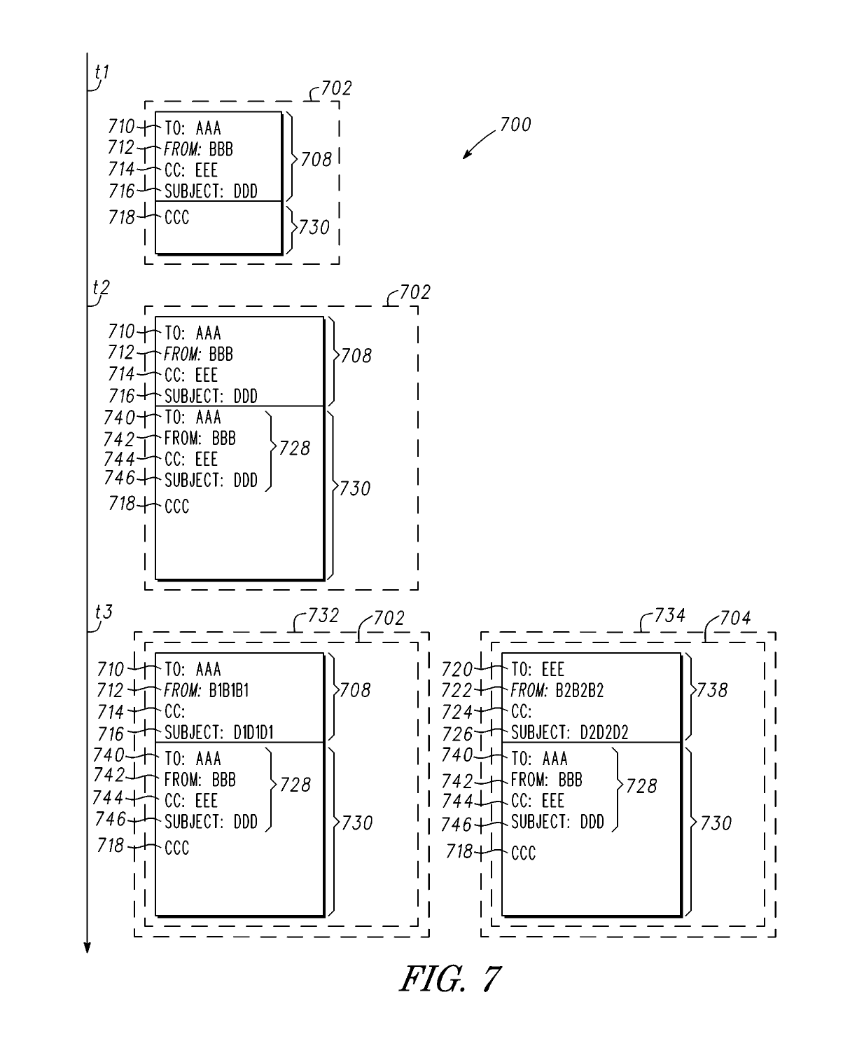

Referring now to FIG. 6 and FIG. 7, FIG. 7 is a greatly simplified exploded schematic illustration 700 of an alternate process for sending secure emails 732 and/or 734. For the sake of clarity and to illustrate functional steps at different periods of relative timing points, times t1, t2, and t3, have been identified. It should be understood that t1, t2, and t3 are relative periods of time and do not reflect actual periods of time or the relative timing between points in time. It should be further understood that the sequencing of functional steps is achieved by both sender's computer device 603 and sender's secure communication device 605. However, it is fully contemplated that in the present invention and in some applications that the software could be consolidated into a single program and run with a single sender's computer device 603. Additionally, it should be understood, that while FIG. 7 illustrates a sequence of steps, use of different technologies, software, hardware, and communication between sender's computer device 603 and sender's secure communication device 605 can alter the sequencing of the steps to improve the efficiencies in light of the technologies used.

As shown in FIG. 7, each original email 702 is made having certain parts or divisions, wherein original email 702 includes a header 708 having a “To:” field 710, a “From:” field 712 which may or may not be shown and is shown herein FIG. 7 in italicized for clarity, a “Cc:” field 714, a “Subject:” field 716, and a content space 730. Content space 730 can be filled with any suitable electronic media such as, but not limited to, textual material, audio material, video material, optical material, or the like and/or any combination thereof, wherein simple textual material illustrated by “CCC” is displayed as content 718 in content space 730 and wherein more complicated and larger files as mention hereinabove may be attached as part of content space 730.

Typically and by way of example only, at t1, the sender launches an email program on computer device 101 which generates original email 702. The sender fills in “To:” field 710 with the receiver's email address which is represented herein by “AAA”. As shown in FIG. 7, the “From:” field 712, is shown in italics, to indicated that, in some instances, “From:” field 712 is observable to the sender and in other instances the “From:” field 712 is not observable. The observability is dependent upon the settings of the email program contained in computer device 101. It should be further understood that “From:” field 712 is typically the sender's own email address and is generally stored in the email program whether the “From:” field 712 is observable or not. Also, it should be understood that the “From:” field 712 is typically filled in with the sender's own email address and is filled in automatically and stored by the sender's own email software because it is the sender's own software and computer device 101 that initiates the original outgoing email 702. The filling in of “Cc” field 714 is optional and is at the discretion of the sender.

Typically, the sender fills in the “Cc:” field 714 with email addresses of other receivers that the sender wants to send original email 702 to. Additionally, it should be understood that the “Cc:” field 714, the “Subject:” field 716, and the Content space 730 do not necessarily have to be filled in or contain any data.

Generally, during the process of filling in the information in header 708, at approximately the same time the original email 702 is initiated by the sender of original email 702, or after the sender sends the original email from sender's computer device 603, the sender's secure communication device 605 can automatically or at the sender's discretion manually modify original email 702 by copying information from the header 708 into the content space 730. This period of time is generally identified and shown as t2. However, it should be understood, that t2 is only a relative timing point wherein several events can be controlled by software in the sender's secure communication device 605 such as, but not limited to the automatic filling in of certain fields such as, but not limited to, the “To:” field 710, the “From:” field 712, the “Cc:” field 714, the “Subject:” field 716, and the Content space 730. At t2, some or all of the electronic information, or metadata, contained in header 708 is copied and placed into content space 730. As illustrated in t2, when the metadata from header 708 is copied and moved into content space 730, the metadata copied from header 708 and placed in content space 730 is identified as header metadata 728 because of the functional difference between being located in the header 708 of original email 702 and being located in the content space 730 of original email 702. Header metadata 728 includes but is it not limited to “To:” field 740, “From:” field 742, “Cc:” field 744, and “Subject:” field 746. As stated previously this electronic information was copied from header 708 and has been assigned unique labels because of the functional difference between being located in the header 708 of original email 702 and being located in the header metadata 728 in content space 730 of original email 702. The functional differences between header 708 and header metadata 728 includes, but are not limited to, the fact that the electronic information in header 708 will be used to process and route original email 702, whereas header metadata 728 will not be used to process or route original email 702. Moreover, header metadata 728 can also be encrypted when using any suitable means to encrypt content space 730. It should also be understood there are other additional benefits to placing header metadata 728 within content space 730 even prior to the encryption of content space 730 such as but not limited to increased expectation of privacy associated with header metadata 728 because it's located in content space 730 compared to a lower expectation of privacy associated with header 708.

Additionally, it should be understood that additional email 704 is generated when a second intended receiver of original email 702 is identified by the sender. In this specific example, a second intended receiver of original email is identified by the sender as “EEE” as shown in “Cc:” field 714. One skilled in the art will recognize that there are a multitude of ways to identify an additional intended receivers including but not limited to adding additional email addresses to the “To:” field 710, “Cc:” field 714, “Bcc:” field (not shown), or the like. In general, when multiple intended receivers are identified by the sender there will be multiple additional emails, exemplified by additional email 704, generated at t3.

It should be understood that “AAA” and “EEE” represent intended receiver persons or devices. The electronic information and format of “AAA” and “EEE” may be presented or used in a multitude of ways that vary from across t1, t2 and t3. For example, the sender may enter a receiver's name or phone number in “To:” field 710 at t1, shown as “AAA”, while the receiver's email address is used in field “To:” field 710 at t2, also shown as “AAA”.

It should also be understood, that t2 and t3 are only relative timing points wherein several events can be controlled by software in the secure communication device 102. For example, the automatic filling of appropriate data in certain fields such as, but not limited to, the “To:” fields 710, 720 and 740 wherein the receiver identified in “To:” fields 710 and 740 at t2 and t3, shown as “AAA”, are derived from or related to information entered by the sender in “To:” field 710 at t1, also shown as “AAA”, wherein the receiver in “To:” field 720 at t3, shown as “EEE”, is derived from or related to information entered by the sender in “Cc:” field 714 at t1, also show as “EEE”. Other examples of the automatic filling of certain fields at t2 or t3 may include but are not limited to, the “From:” fields 712, 722 and 742, the “Cc:” fields 714, 724 and 742, the “Subject:” fields 716, 726 and 746, headers 708 and 738, header metadata 728, Content space 730, content 718 and the like.

As shown in FIG. 7 at t3, some of the electronic information in headers 708 and 738 of original email 702 and additional email 704 including but not limited to “From:” fields 710 and 722, “Cc:” fields 714 and 724, “Subject:” fields 716 and 726 and the like, are replaced and/or modified to protect their original content. It should be understood that any suitable means can be used to replace or modify the electronic information in headers 708 and 738 so as to protect the information contained in headers 708 and 738 of original email 702 and additional email 704, respectively.

By way of example, in the case of “Cc:” field 714 at t2 the electronic information, show as “EEE”, is copied into header metadata 728 in content space 730 where it can be encrypted and at t3 the electronic information in “Cc:” fields 714 and 724 is deleted. Deletion is used for “Cc:” fields 714 and 724 at t3 because “Cc:” fields 714 and 724 are not considered mandatory for sending email.

In the case of “Subject:” field 716 at t2 the electronic information (plaintext), show as “DDD”, is encrypted in place. The resulting ciphertext is shown as “D1D1D1” in “Subject:” field 716 of header 708 of original email 702 at t3 and as “D2D2D2” in “Subject:” field 726 of header 738 of additional email 704 at t3. The resulting ciphertext is shown as “D1D1D1” in “Subject:” field 716 of header 708 of original email 702 at t3 and as “D2D2D2” in “Subject:” field 726 of header 738 of additional email 704 at t3 because a pseudo-random mode of operation is used, such as but not limited to Cipher-Block Chaining (CBC), Propagating Cipher-Block Chaining (PCBC), Cipher Feedback (CFB), or the like. As a result, even if information in the original email 702 and additional email 704 were encrypted using the same public key the same input plaintext, “DDD”, would result in different output ciphertext “D1D1D1” versus “D2D2D2”. This ensures a 3^{rd} party cannot track information that is repeated in email correspondence, such as but not limited to the content of the “Subject:” field. “Subject:” field 746 is shown in header metadata 728 in content space 730 of original email 702 and additional email 704 for the sake of completeness and clarity. However, one of ordinary skill in the art would recognize that it is not necessary to copy the electronic information in “Subject:” field 716 in header 708 at t2 to “Subject:” field 746 in header metadata 728 in content space 730 at t3 because that electronic information can be decrypted by the receivers of original email 702 and additional email 704 using the ciphertext in “Subject:” fields 716 and 726, respectively. Encryption in place is used for “Subject:” fields 716 and 726 at t3 because “Subject:” fields 716 and 726 have few restriction on formatting or content and thus the ciphertext resulting from encrypting the plaintext is unlikely to result in the email being blocked by email service providers.

In the case of “From:” fields 712 at t2 the electronic information, shown as “BBB”, is copied into header metadata 728 in content space 730 where it can be encrypted and at t3 the electronic information in “From:” fields 712 and 722 is modified by either randomly assigning a novel and/or unique email address or manually by filling the “From:” fields 712 and 722 with a novel email address, represented herein by “B1B1B1” and “B2B2B2,” respectively. Randomly assigning a novel and/or unique email address or manually by filling “From:” fields 712 and 722 with a novel email address is used because the electronic information in “From:” fields 712 and 722 generally have to follow strict formatting requirements, and is used by email service providers to identify spam or malicious email that should be filtered or deleted before it is passed on to the receiver. The electronic information in “From:” fields 712 and 722 are also used for automated reply messages, such as but not limited to, out of office messages and the like. As a result, it is desirable to use novel and/or unique information designed to bypass the filters traditionally used to identify spam or malicious emails by email service providers to ensure delivery of original email 702 and additional email 704 to their intended receivers. In addition, it may also be desirable to use valid email addresses in “From:” fields 712 and 722 that are not associated with the sender so that any automated reply messages can be retrieved by the sender.

As seen in FIG. 7 at t3, the “From:” field 742, “Cc:” field 744 and “Subject:” field 746 in header metadata 728 located in content space 730 in original email 702 and additional email 704 have not been modified. Content space 730 in original email 702 and additional email 704 is then encrypted by any suitable encryption standard such as, but not limited to, Secure/Multipurpose Internet Mail Extensions (S/MIME) or the like. Encrypting content space 730 including header metadata 728 and content 718 generates secure emails 732 and 734.

By placing header metadata 728 into Content space 730 of original email 702 and additional email 704 and using any suitable encryption standard such as, but not limited to, Secure/Multipurpose Internet Mail Extensions (S/MIME), the original email 702 and additional email 704, including header metadata 728, can be encrypted, prior to sending to the intended receivers, despite the fact that encryption normally does not allow for encryption of electronic information found in header 708 of original email 702. This creates secure emails 732 and 734. The email is considered secure because both the content space 730 and header metadata 728 of the original email 702 are protected. In addition, the headers 708 and 738 of original email 702 and additional 704 at t3 do not expose information contained in header 708 of original email 702 at t2. By way of example only, information contained in headers 708 and 738 at t3 that is no longer exposed includes but is not limited to the “From:” field 712, “Cc:” field 714, “Subject:” field 716, and the like.

Further, the present invention allows for additional privacy and security of protected information such as metadata in header 708 of original email 702, including but not limited to the sender's identifying information, the subject, the number of intended receivers, or the identifying information of other intended receivers. This protected information is not capable of being secured by using other conventional methods and procedures commonly used when attempting to secure email or electronic communications. However, in the present invention this protected information has been secured.

Moreover, encrypting the header metadata prior to sending the electronic communication secures this protected information from being viewed by 3rd parties and service providers as the electronic communication travels to its intended receiver. Thus, the present invention further protects individuals from identification of their long-term, frequently contacted, and discreetly held associations, by preventing electronic communication metadata from being exposed and analyzed over time.

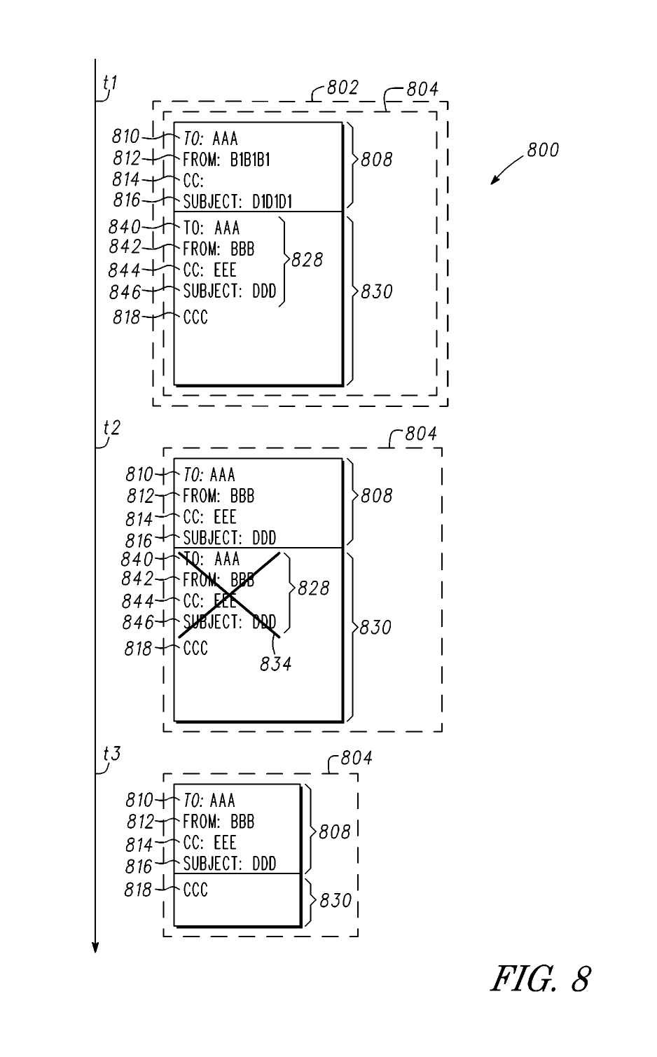

Referring now to FIG. 6 and FIG. 8, FIG. 8 is a greatly simplified exploded schematic illustration 800 of an alternate process of receiving a secure email 802. As shown in FIG. 8, secure email 802 includes an original email 804, wherein original email 804 includes a header 808 including but not limited to a “To:” field 810 which may or may not be shown and is shown herein FIG. 8 in italics for clarity, a “From:” field 812, a “Cc:” field 814, a “Subject:” field 816. Original email 804 also includes a content space 830. Content space 830 can include any inputted suitable electronic media such as, but not limited to, textual material, audio material, optical material, or the like. Simple textual material “CCC” is displayed in the content space 830 as a content 818 and wherein files or data streams as mention hereinabove may be added to Content space 830 as attachments.

Typically and by way of example only, at t1, receiver's secure communication device 634, as shown in FIG. 6, launches an email program which retrieves secure email 802 from Receiver's Email Service Provider 652, as shown in FIG. 6. Receiver's secure communication device 634 recognizes secure email 802. Once receiver's secure communication device 634 recognizes secure email 802, receiver's secure communication device 634 decrypts content space 830 of secure email 802 to a readable status by using the private key associated with receiver's email address which is identified in “To:” field 810 thus enabling the receiver's secure communication device 634 to read content space 830. Also, it should be understood that by decrypting content space 830, content 818 and a header metadata 828 including but not limited to a “To:” field 840, a “From:” field 842, a “Cc:” field 844, a “Subject:” field 846 are now readable.

With content space 830 being decrypted and capable of being read, any suitable action can be launched with regards to information stored in content space 830. Actions can include restoring header metadata 828 from content space 830 to the header 808, deleting header metadata 828 from content space 830, and only delivering original email 804 as shown at t3 to the receiver's computer device 634. These actions may be chosen and implemented manually by the receiver, or may be chosen and implemented automatically by receiver's secure communication device 634. By way of example only and as shown in FIG. 8, at t2, receiver's secure communication device 634 restores header 808 to its original form (as generated by the sender and seen as original email 702 in FIG. 7) using header metadata 828 from the content space 830. By way of example only and as shown in FIG. 8, receiver's secure communication device 634 has also automatically deleted the header metadata 828 from content space 830. This action is illustrated by an X 834 being drawn though header metadata 828 at t2 of FIG. 8. With header metadata 828 at t2 being deleted, only original email 804 along with its header 808 and space for content 830 remain to be delivered to the receiver's computer device 632 where it can be read by the receiver as shown at t3 of FIG. 8 with the assurance that the security, integrity, and privacy of the original email 804 has been maintained.

It may be desirable for receiver's secure communication device 634 to process secure email 802 and original email 804 optionally as shown in FIG. 8 prior to delivering it to receiver's computer device 632 to provide the receiver with additional benefits. These benefits may include but are not limited to compatibility with existing email programs, the ability to search for keywords, and transparency of security features to the receiver.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A method for securing an electronic communication comprising the steps of:
providing a computer device capable of electronic communication; and
generating a first electronic communication having a header, wherein the header includes metadata and wherein at least a portion of the metadata is encrypted.

2. The method for securing the electronic communication as claimed in claim 1, wherein the step of generating the electronic communication having the header, wherein the header further includes metadata identifying a sender.

3. The method for securing the electronic communication as claimed in claim 1, wherein the step of generating the electronic communication having the header, wherein the header further includes metadata identifying a receiver.

4. The method for securing the electronic communication as claimed in claim 2, wherein the step of generating the first electronic communication having metadata that identifies the sender and wherein the metadata that identifies the sender is encrypted.

5. The method for securing the electronic communication as claimed in claim 1 wherein the step of generating the electronic communication further includes generating a content space.

6. The method for securing the electronic communication as claimed in claim 5 wherein the content space is encrypted.

7. The method for securing the electronic communication as claimed in claim 1 wherein the at least one portion of the metadata is encrypted by a pseudo-random mode of operation.

8. The method for securing the electronic communication as claimed in claim 4 wherein the metadata identifying the sender is encrypted by a pseudo-random mode of operation.

9. The method for securing the electronic communication system as claimed in claim 4 wherein the metadata identifying the sender is novel.

10. A secure communication system comprising:
a first computer device having a first processor having a first input and a first output, a first I/O interface having a second input and a second output, a first memory device having a third input and a third output, and a bus line, the first processor electrically coupled to and communicable to the first I/O interface, and the first memory device coupled to and communicable to the first I/O interface via the first bus line;
a first electronic communication having a first sender, a first receiver, and a first content space located in the first memory device and electrically coupled to the first processor for processing of the electronic communication; and
a second electronic communication having a second sender, a second receiver, and a second content space, wherein the first electronic communication is placed into the second content space.

11. The secure communication system as claimed in claim 10 wherein the second content space of the second electronic communication is encrypted.

12. The secure communication system as claimed in claim 10 wherein the first computer device is capable of receiving electronic communications.

13. The secure communication system as claimed in claim 11 wherein the first computer device is capable of decrypting the second content space of the second electronic communication.

14. The secure communication system as claimed in claim 13 wherein the second content space is decrypted by an asymmetric key algorithm.

15. The secure communication system as claimed in claim 10 wherein the first computer device of parsing the first electronic communication including the first sender, the first receiver, and the first content space from the second content space in the second electronic communication allowing the first electronic communication to be processed separately from the second electronic communication.

16. The secure communication system as claimed in claim 10 wherein a second computer device having a second processor having a fourth input and a fourth output, a second I/O interface having a fifth input and a fifth output, a second memory device having a sixth input and a sixth output, and a second bus line, the second processor electrically coupled to and communicable to the second I/O interface, and the second memory device via the second bus line.

17. The secure communication system as claimed in claim 10 wherein the second computer device is able to install software on or configure the first computer device to be used as part of the secure communication system.

18. The secure communication system as claimed in claim 10 wherein the second computer device is able to act as a virtual private network (VPN) server to protect mobile computer devices that may leave the local area network (LAN).

19. The secure communication system as claimed in claim 10 wherein the second computer device is able to create or register second electronic communication accounts.

20. The secure communication system as claimed in claim 10 wherein the second computer device is able to access public key information from at least one remote computer device.

21. The secure communication system as claimed in claim 10 wherein the second computer device is able to send public key information to at least one remote computer device.

22. The secure communication system as claimed in claim 10 wherein the second computer device is able to obscure its IP address.

23. A method for making and securing an electronic communication from a computer device comprising the steps of:
generating a first electronic communication having a first content space and a first metadata, the first metadata including a first value;
generating a second electronic communication having a second content space and a second metadata, the second metadata including a second value; and
placing the first electronic communication into the second content space of the second electronic communication.

24. The method for making and securing an electronic communication from a computer device as claimed in claim 23 wherein the first value of the first electronic communication is information that can be used to identify the sender of the first electronic communication.

25. The method for making and securing an electronic communication from a computer device as claimed in claim 24 wherein the first value is an email address.

26. The method for making and securing an electronic communication from a computer device as claimed in claim 24 wherein the first value is a username.

27. The method for making and securing an electronic communication from a computer device as claimed in claim 24 wherein the first value is a phone number.

28. The method for making and securing an electronic communication from a computer device as claimed in claim 24 wherein the first value is an IP address.

29. The method for making and securing an electronic communication from a computer device as claimed in claim 24 wherein the first value is a plurality of values that can be used to identify the sender of the first electronic communication.

30. The method for making and securing an electronic communication from a computer device as claimed in claim 24 wherein the first value is a plurality of values that can be used to partially identify the sender of the first electronic communication.

31. The method for making and securing an electronic communication from a computer device as claimed in claim 23 wherein the second value of the second electronic communication can be used to identify the sender of the second electronic communication.

32. The method for making and securing an electronic communication from a computer device as claimed in claim 31 wherein the second value is an email address.

33. The method for making and securing an electronic communication from a computer device as claimed in claim 31 wherein the second value is a username.

34. The method for making and securing an electronic communication from a computer device as claimed in claim 31 wherein the second value is a phone number.

35. The method for making and securing an electronic communication from a computer device as claimed in claim 31 wherein the second value is an IP address.

36. The method for making and securing an electronic communication from a computer device as claimed in claim 31 wherein the second value is a plurality of values that can be used to identify the sender of the second electronic communication.

37. The method for making and securing an electronic communication from a computer device as claimed in claim 31 wherein the second value is a plurality of values that can be used to partially identify the sender of the second electronic communication.

38. The method for making and securing an electronic communication from a computer device as claimed in claim 23 wherein the second value cannot be used to identify the first value.

39. A secure electronic communication comprising:
a first secure electronic communication having a first header with a To: field, first other fields, and a first content space, wherein the first content space is encrypted; and
a second secure electronic communication, wherein the second secure communication is encrypted and wherein the second secure communication is located in the first content space of the first electronic communication.

40. A secure electronic communication as claimed in claim 39 wherein the other fields are encrypted.

41. A secure electronic communication as claimed in claim 39 wherein the first secure electronic communication is a plurality of the secure communications.

42. A secure electronic communication as claimed in claim 39 wherein the other fields of the first electronic communication are encrypted.

43. A secure electronic communication as claimed in claim 39 wherein the second secure communication includes a second header and a second content space and wherein the second electronic communication is encrypted.

44. A method for securing an electronic communication comprising the steps of:
providing a computer device capable of generating electronic communication;
generating a first electronic communication having metadata identifying a first sender having a first value, having metadata identifying a first receiver having a second value, and a first content space having a third value;
generating a second electronic communication having metadata identifying a second sender having a fourth value, having metadata identifying a second receiver having a fifth value, and a second content space having a sixth value; and
placing the first electronic communication into the second content space of the second electronic communication.

45. The method for securing an electronic communication as claimed on claim 44 wherein the first value and the forth value are not same.

46. The method for securing an electronic communication as claimed on claim 44 wherein the second value and the fifth value are the same.

47. The method for securing an electronic communication as claimed on claim 44 wherein the second content space of the second electronic communication is encrypted prior to sending.

48. The method for securing an electronic communication as claimed on claim 47 wherein the second content space of the second electronic communication is encrypted by a pseudo-random mode of operation.

49. The method for securing an electronic communication as claimed on claim 44 wherein the first electronic communication and the second electronic communication are different types.

50. The method for securing an electronic communication as claimed on claim 44 wherein the computer device is capable of registering novel accounts that are not associated with the sender.

51. The method for securing an electronic communication as claimed on claim 44 wherein the computer device is capable of obscuring its IP address.

52. The method for securing an electronic communication as claimed on claim 44 wherein the computer device is capable of generating a public key and a private key.

53. The method for securing an electronic communication as claimed on claim 52 wherein the computer device is capable of sending the generated public key.

54. The method for securing an electronic communication as claimed on claim 44 wherein the computer device is capable of receiving public keys.

55. The method for securing an electronic communication as claimed on claim 44 wherein the computer device is capable of modifying the metadata of the first electronic communication.

56. The method for securing an electronic communication as claimed on claim 44 wherein the computer device is capable of modifying the metadata of the second electronic communication.

57. The method for securing an electronic communication as claimed on claim 44 wherein the computer device is capable of generating novel metadata.
